(19) United States
(12) Patent Application Publication
(10) Pub. No.: US 2025/0150212 A1
(43) Pub. Date: May 8, 2025

(54) SIDELINK OPERATION IN UNLICENSED SPECTRUM

(71) Applicant: InterDigital Patent Holdings, Inc., Wilmington, DE (US)

(72) Inventors: Kyle Jung-Lin Pan, Saint James, NY (US); Guodong Zhang, Woodbury, NY (US); Pascal Adjakple, Great Neck, NY (US); Patrick Svedman, Stockholm (SE); Yifan Li, Conshohocken, PA (US)

(73) Assignee: InterDigital Patent Holdings, Inc., Wilmington, DE (US)

(21) Appl. No.: 18/681,322

(22) PCT Filed: Aug. 5, 2022
(86) PCT No.: PCT/US2022/039550

§ 371 Date: Feb. 5, 2024

Related U.S. Application Data
(60) Provisional application No. 63/229,795, filed on Aug. 5, 2021.

(51) Int. Cl. H04L 1/1825; H04L 5/00; H04W 72/25; H04W 74/0808

(52) U.S. Cl. CPC H04L 1/1825; H04L 5/0055; H04W 72/25; H04W 74/0808

(57) ABSTRACT

Methods, systems, and. devices may assist in new radio (NR) sidelink (SL) operation in licensed or unlicensed spectrum. In an example, if listen-before-talk (LBT) failure rate is low, then implicit acknowledgement (ACK) and explicit non-acknowledgement (NACK) may be used. A first SL timer may start when a. SL transport block is transmitted. If no explicit NACK, is received before the SL timer expires, then ACK. may be assumed. If LBT failure rate is high, then explicit ACK and implicit NACK may be used. A second SL timer may start. If no explicit ACK is received before the SL timer expires, then NACK may be assumed.

### CROSS-REFERENCE TO RELATED APPLICATIONS

This application claims the benefit of U.S. Provisional Patent Application No. 63/229,795, filed on Aug. 5, 2021, entitled “NR SI Enhancement and Operation in Unlicensed Spectrum,” the contents of which are hereby incorporated by reference herein.

### BACKGROUND

New radio (NR) vehicle-to-everything (V2X) is designed with a broader set of more advanced V2X use cases in mind and are broadly arranged into four use case groups: vehicular platooning, extended sensors, advanced driving, and remote driving.

A first use case group is vehicles platooning that enables the vehicles to dynamically form a platoon travelling together. All the vehicles in the platoon obtain information from the leading vehicle to manage this platoon. The information allows the vehicles to drive closer than normal in a coordinated manner, going to the same direction and travelling together.

A second use case group is extended sensors that enables the exchange of raw or processed data gathered through local sensors or live video images among vehicles, road site units, devices of pedestrian and V2X application servers. The vehicles can increase the perception of their environment beyond of what their own sensors can detect and have a more broad and holistic view of the local situation. High data rate is one of the key characteristics.

A third use case group is advanced driving that enables semi-automated or full-automated driving. Each vehicle or RSU shares its own perception data obtained from its local sensors with vehicles in proximity and that allows vehicles to synchronize and coordinate their trajectories or maneuvers. Each vehicle shares its driving intention with vehicles in proximity too.

A fourth use case is remote driving that enables a remote driver or a V2X application to operate a remote vehicle for those passengers who cannot drive by themselves, or remote vehicles located in dangerous environments. For a case where variation is limited and routes are predictable, such as public transportation, driving based on cloud computing can be used. High reliability and low latency are the main requirements.

The 5G requirements versus that of LTE V2V requirement is summarized in FIG. 1.

The most demanding requirements set are for a maximum sidelink range of 1000 m, a maximum throughput of 1 Gbps, a shortest latency of 3 ms, a maximum reliability of 99.999%, and a maximum transmission rate of 100 messages/second. Other challenging requirements may also include mobility relative speed and positioning accuracy. However, there is not a use case which, on its own, demands all of these bounding requirements. There are also requirements relating to security, integrity, authorization, and privacy.

NR V2X has physical layer support for broadcast, unicast, and groupcast sidelink operation. The addition of unicast and groupcast is linked with the introduction of sidelink HARQ feedback, high order modulation, sidelink CSI, and PC5-RRC, etc.

The NR V2X sidelink uses the following physical channels and signals:
Physical sidelink broadcast channel (PSBCH) and its DMRS
Physical sidelink control channel (PSCCH) and its DMRS
Physical sidelink shared channel (PSSCH) and its DMRS
Physical sidelink feedback channel (PSFCH)
Sidelink primary and secondary synchronization signals (S-PSS and S-SSS) which are organized into the sidelink synchronization signal block (S-SSB) together with PSBCH. S-PSS and S-SSS can be referred to jointly as the sidelink synchronization signal (SLSS).
Phase-tracking reference signal (PT-RS) in FR2
Channel state information reference signal (CSI-RS)

NR-V2X sidelink supports subcarrier spacings of 15, 30, 60 and 120 KHz. Their associations to CPs and frequency ranges are as for NR UL/DL, but using only the CP-OFDM waveform. The modulation schemes available are QPSK, 16-QAM, 64-QAM, and 256-QAM.

PSBCH transmits the SL-BCH transport channel, which carries the sidelink V2X Master Information Block (MIB-V2X) from the RRC layer. When in use, PSBCH transmits MIB-V2X every 160 ms in 11 RBs of the SL bandwidth, with possible repetitions in the period. DMRS associated with PSBCH are transmitted in every symbol of the S-SSB slot. S-PSS and S-SSS are transmitted together with PSBCH in the S-SSB. They jointly convey the SLSS ID used by the UE.

Sidelink control information (SCI) in NR V2X is transmitted in two stages. The first-stage SCI is carried on PSCCH and contains information to enable sensing operations, as well as information about the resource allocation of the PSSCH.

PSSCH transmits the second-stage SCI and the SL-SCH transport channel. The second-stage SCI carries information needed to identify and decode the associated SL-SCH, as well as control for HARQ procedures, and triggers for CSI feedback, etc. SL-SCH carries the transport block (TB) of data for transmission over SL.

The resources in which PSSCH is transmitted can be scheduled or configured by a gNB or determined through a sensing procedure conducted autonomously by the transmitting UE. A given TB can be transmitted multiple times. DMRS associated with rank-1 or rank-2 PSSCH can be transmitted in 2, 3, or 4 sidelink symbols distributed through a sidelink slot. Multiplexing between PSCCH and PSSCH is in time and frequency within a slot.

PSFCH carries HARQ feedback over the sidelink from a UE which is an intended recipient of a PSSCH transmission (henceforth an Rx UE) to the UE which performed the transmission (henceforth a Tx UE). Sidelink HARQ feedback may be in the form of conventional ACK/NACK, or NACK-only with nothing transmitted in case of successful decoding. PSFCH transmits a Zadoff-Chu sequence in one PRB repeated over two OFDM symbols, the first of which can be used for AGC, near the end of the sidelink resource in a slot. The time resources for PSFCH are (pre-)configured to occur once in every 1, 2, or 4 slots.

Resource allocation modes are disclosed below.

Mode 1 is for resource allocation by gNB. The use cases intended for NR V2X can generate a diverse array of periodic and aperiodic message types. Therefore, resource allocation mode 1 provides dynamic grants of sidelink resources from a gNB, as well as grants of periodic sidelink resources configured semi-statically by RRC.

A dynamic sidelink grant DCI can provide resources for one or more transmissions of a transport block, in order to allow control of reliability. The transmission(s) can be subject to the sidelink HARQ procedure, if that operation is enabled.

A sidelink configured grant can be such that it is configured once and can be used by the UE immediately, until it is released by RRC signalling (known as Type 1). A UE is allowed to continue using this type of sidelink configured grant when beam failure or physical layer problems occur in NR Uu until an RLF detection timer expires, before falling back to an exception resource pool. The other type of sidelink configured grant, known as Type 2, is configured once but cannot be used until the gNB sends the UE a DCI indicating it is now active, and only until another DCI indicates de-activation. The resources in both types are a set of sidelink resources recurring with a periodicity which a gNB will desire to match to the characteristics of the V2X traffic. Multiple configured grants can be configured, to allow provision for different services, traffic types, etc.

MCS information for dynamic and configured grants can optionally be provided or constrained by RRC signaling instead of the traditional DCI. RRC can configure the exact MCS the Tx UE uses, or a range of MCS. It may also be left unconfigured. For the cases where RRC does not provide the exact MCS, the transmitting UE is left to select an appropriate MCS itself based on the knowledge it has of the TB to be transmitted and, potentially, the sidelink radio conditions.

Mode 2 is for UE autonomous resource selection. Its basic structure is of a UE sensing, within a (pre-)configured resource pool, which resources are not in use by other UEs with higher-priority traffic, and choosing an appropriate amount of such resources for its own transmissions. Having selected such resources, the UE can transmit and re-transmit in them a certain number of times, or until a cause of resource reselection is triggered.

The mode 2 sensing procedure can select and then reserve resources for a variety of purposes reflecting that NR V2X introduces sidelink HARQ in support of unicast and groupcast in the physical layer. It may reserve resources to be used for a number of blind (re-)transmissions or HARQ-feedback-based (re-)transmissions of a transport block, in which case the resources are indicated in the SCI(s) scheduling the transport block. Alternatively, it may select resources to be used for the initial transmission of a later transport block, in which case the resources are indicated in an SCI scheduling a current transport block. Finally, an initial transmission of a transport block can be performed after sensing and resource selection, but without a reservation.

The first-stage SCIs transmitted by UEs on PSCCH indicate the time-frequency resources in which the UE will transmit a PSSCH. These SCI transmissions are used by sensing UEs to maintain a record of which resources have been reserved by other UEs in the recent past.

The sensing UE then selects resources for its (re-)transmission(s) from within a resource selection window. The window starts shortly after the trigger for (re-)selection of resources, and cannot be longer than the remaining latency budget of the packet due to be transmitted. Reserved resources in the selection window with SL-RSRP above a threshold are excluded from being candidates by the sensing UE, with the threshold set according to the priorities of the traffic of the sensing and transmitting UEs. Thus, a higher priority transmission from a sensing UE can occupy resources which are reserved by a transmitting UE with sufficiently low SL-RSRP and sufficiently lower-priority traffic.

BWPs are defined for the sidelink in a similar way as for UL/DL, to provide a convenient way to specify aspects relating to a UEs RF hardware chain implementation. A UE is configured with one active sidelink BWP when in connected mode to a gNB, which is the same as the single sidelink BWP used for idle mode or out-of-coverage operation.

The subcarrier spacing used on sidelink is provided in the sidelink BWP (pre-)configuration, from the same set of values and associations to frequency ranges as for the Uu interface (i.e. 15, 30, or 60 kHz for FR1; and 60 or 120 KHz for FR2). Sidelink transmission and reception for a UE are thus contained within a sidelink BWP, and the same sidelink BWP is used for both transmitting and receiving. This means that resource pools, S-SSB, etc. must also be contained within an appropriate sidelink BWP from the UE's perspective.

This background information is provided to reveal information believed by the applicant to be of possible relevance. No admission is necessarily intended, nor should be construed, that any of the preceding information constitutes prior art.

### SUMMARY

Disclosed herein are methods, systems, and devices that may assist in NR SL operation in licensed and unlicensed spectrum, such as the following subject matter.

To enable sidelink operation in unlicensed spectrum, one approach may allow a UE share the Channel Occupancy Time (COT) with one or more other UEs. TX UE may share the COT with one or more RX UEs. TX UE may also share the COT with one or more other TX UEs. A UE may initiate the COT. SL COT may be shared based on SL transmission gap, SL transmission duration, etc.

SL LBT parameters may be sent in SCI. LBT type or LBT category may be carried in SCI. SL control or data channel may use one of LBT types or LBT categories. If such LBT type or LBT category is not needed for SL, then UE may switch to another LBT type or LBT category. Such switch may be implicit or explicit.

To reduce power, a resource, resource pool, resource partition, resource pool partition or the like may be indicated. If resource, resource pool, resource partition, resource pool partition is occupied, then UE may skip the monitoring of SCI or PSCCH for the indicated resource or partition. If resource, resource pool, resource partition, resource pool partition is not occupied, then UE may monitor for the SCI or PSCCH for the indicated resource or partition.

To further save power, UE may be configured with two PSCCH monitoring modes. UE may dynamically switch the PSCCH monitoring modes. UE may switch the PSCCH monitoring modes using implicit switch or explicit switching. UE may be configured with implicit or explicit switching for PSCCH monitoring mode.

To enhance reliability for SL feedback and reduce retransmission for SL, a SL feedback pending indication may be used. Tx UE may send a SCI including a SL feedback pending indication control field. If such SL control field indicates that UE feedback is pending, RX UE may wait for next SCI and decode SCI to receive data accordingly. UE may send the feedback e.g., HARQ ACK/NACK for the current new data and previous data that are scheduled by SCI.

TX UE may request RX UE to retransmit UE feedback. SL feedback retransmission indication may be sent to RX UE e.g., via SCI. If RX UE receives feedback retransmission request, RX UE may retransmit the UE feedback e.g., HARQ ACK/NACK back to TX UE e.g., via PSFCH. For example, RX UE may retransmit the feedback for HARQ processors.

If LBT failure rate is low, then implicit ACK and explicit NACK may be used. If LBT failure rate is high, then explicit ACK and implicit NACK may be used. When LBT failure rate is low and implicit ACK and explicit NACK are used, a first SL timer may be configured. A first SL timer (timer 1) may start when a SL transport block is transmitted. If no explicit NACK is received before the SL timer expires, then ACK may be assumed. If explicit NACK is received, then transport block may be retransmitted to RX UE.

When LBT failure rate is high and explicit ACK and implicit NACK are used, a second SL timer may be configured. A second SL timer (timer 2) may start when a SL transport block is transmitted. If no explicit ACK is received before the SL timer expires, then NACK may be assumed. SL transport block may be retransmitted to RX UE. If explicit ACK is received before a second timer expires, then transport block is not needed to be retransmitted to RX UE,

To reduce overhead for explicit ACK feedback, a sidelink ACK feedback indicator (SL-AFI) may be introduced. SL-AFI may be used to indicate the status of HARQ processes ACK or NACK. For example, a bitmap may be used for SL-AFI.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 illustrates an exemplary Summary of 5G V2X versus LTE V2V Requirement;

FIG. 2 illustrates an exemplary system that may implement SL operation in unlicensed spectrum;

FIG. 3 illustrates an exemplary method of LBT conditions and procedures;

FIG. 4 illustrates an exemplary method of COT, LBT conditions and procedures;

FIG. 5 illustrates an exemplary method of LBT type indication and switching procedure;

FIG. 6 illustrates an exemplary method of resource or partition indication for PSCCH monitoring (e.g., SL-SFI) for power saving;

FIG. 7 illustrates an exemplary method of PSCCH monitoring (explicit) for power saving;

FIG. 8 illustrates an exemplary method of PSCCH monitoring (implicit) for power saving;

FIG. 9 illustrates an exemplary method of PSCCH monitoring switching with default mode;

FIG. 10 illustrates an exemplary method of SL feedback pending indication;

FIG. 11 illustrates an exemplary method of SL feedback timing procedure;

FIG. 12 illustrates an exemplary method of SL feedback retransmission procedure;

FIG. 13 illustrates an exemplary method of SL retransmission procedures;

FIG. 14 illustrates an exemplary method of SL SL-AFI procedures;

FIG. 15 illustrates an exemplary display (e.g., graphical user interface) that may be generated based on the methods, systems, and devices of NR SL operation in licensed or unlicensed spectrum;

FIG. 16A illustrates an example communications system;

FIG. 16B illustrates an exemplary system that includes RANs and core networks;

FIG. 16C illustrates an exemplary system that includes RANs and core networks;

FIG. 16D illustrates an exemplary system that includes RANs and core networks;

FIG. 16E illustrates another example communications system;

FIG. 16F is a block diagram of an example apparatus or device, such as a WTRU; and

FIG. 16G is a block diagram of an exemplary computing system.

### DETAILED DESCRIPTION

In order to support wide range of services, 5G NR system aims to be flexible enough to meet the connectivity requirements of a range of existing and future (as yet unknown) services to be deployable in an efficient manner. In particular, NR considers supporting potential use of frequency range up to 100 GHz.

NR specifications that have been developed in Rel-15 and Rel-16 define operation for frequencies up to 52.6 GHz, where physical layer channels, signals, procedures, and protocols are designed to be optimized for uses under 52.6 GHz.

However, frequencies above 52.6 GHz are faced with more difficult challenges, such as bigher phase noise, larger propagation loss due to high atmospheric absorption, lower power amplifier efficiency, and strong power spectral density regulatory requirements in unlicensed bands, compared to lower frequency bands. Additionally, the frequency ranges above 52.6 GHz potentially contain larger spectrum allocations and larger bandwidths that are not available for bands lower than 52.6 GHz.

As an initial effort to enable and optimize 3GPP NR system for operation in above 52.6 GHz, 3GPP RAN has studied requirements for NR beyond 52.6 GHz up to 114.25 GHz including global spectrum availability and regulatory requirements (including channelization and licensing regimes), potential use cases and deployment scenarios, and NR system design requirements and considerations on top of regulatory requirements. The potential use cases identified in the study include high data rate eMBB, mobile data offloading, short range high-data rate D2D communications, broadband distribution networks, integrated access backhaul (LAB), factory automation, industrial IoT (IIoT), wireless display transfer, augmented reality (AR)/virtual reality (VR) wearables, intelligent transport systems (ITS) and V2X, data center inter-rack connectivity, smart grid automation, private networks, and support of high positioning accuracy. The use cases span over several deployment scenarios identified in the study. The deployment scenarios include, but not limited to, indoor hotspot, dense urban, urban micro, urban macro, rural, factor hall, and indoor D2D scenarios. The study also identified several system design requirements around waveform, MIMO operation, device power consumption, channelization, bandwidth, range, availability, connectivity, spectrum regime considerations, and others.

Among the frequencies of interest, frequencies between 52.6 GHz and 71 GHz are especially interesting relatively in the short term because of their proximity to sub-52.6 GHz for which the current NR system is optimized and the imminent commercial opportunities for high data rate communications, e.g., unlicensed spectrum but also licensed spectrum between 57 GHz and 71 GHz.

NR Rel-15 defined two frequency ranges for operation:

FR1 spanning from 410 MHz to 7.125 GHz

FR2 spanning from 24.25 GHz to 52.6 GHz

The proximity of this frequency range (57-71 GHz) to FR2 and the imminent commercial opportunities for high data rate communications makes it compelling for 3GPP to address NR operation in this frequency regime. In order to minimize the specification burden and maximize the leverage of FR2 based implementations, 3GPP has decided to extend FR2 operation up to 71 GHz with the adoption of one or more new numerologies (e.g., larger subcarrier spacings). That or those new numerologies will be identified by the study on waveform for NR>52.6 GHz. NR-U defined procedures for operation in unlicensed spectrum will also be leveraged towards operation in the unlicensed 60 GHz band. NR operation may support up to 71 GHz considering, both, licensed and unlicensed operation, Similar to regular NR and NR-U operations below 52.6 GHz, NR/NR-U operation in the 52.6 GHz to 71 GHz can be in stand-alone or aggregated via CA or DC with an anchor carrier.

In Release-16 New Radio Unlicensed (NR-U), The supported numerology (e.g. SCS) can be set as 15, 30, and 60 KHz. The listen before talk (LBT) bandwidth is set to 20 MHz in Release-16 NR-U. Based on the minimum LBT bandwidth must be supported, the DL initial BWP is nominally 20 MHz for Rel-16 NR-U. The maximum supported channel bandwidth is set to 100 MHz. The UE channel bandwidth (or an activated BWP) can be set as an integer multiple of LBT bandwidth (e.g. 20 MHz). For instance, for SCS=30 KHz, the total allocated PRB numbers for 20 MHz, 40 MHz and 80 MHz bandwidth is equal to 48, 102, and 214, respectively.

Conventional issue include that current NR SL may not support operation in unlicensed band. Due to channel uncertainty in SL, enhancement to SL LBT procedures, use of LBT types, SL COT acquisition and sharing, etc. are required. In addition, due to frequent monitoring of SL control information, power consumption may be high. To reduce power consumption, approaches to enable power saving may be utilized. To mitigate channel uncertainty for HARQ retransmission, enhancement to HARQ feedback may be utilized. To reduce overhead for ACK/NACK feedback, enhancement of HARQ process may be utilized.

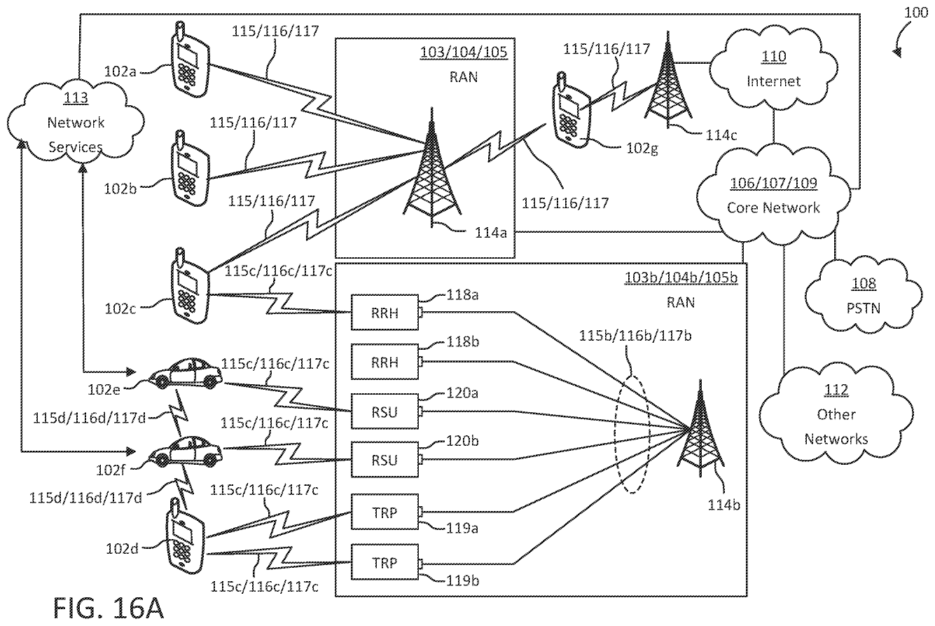

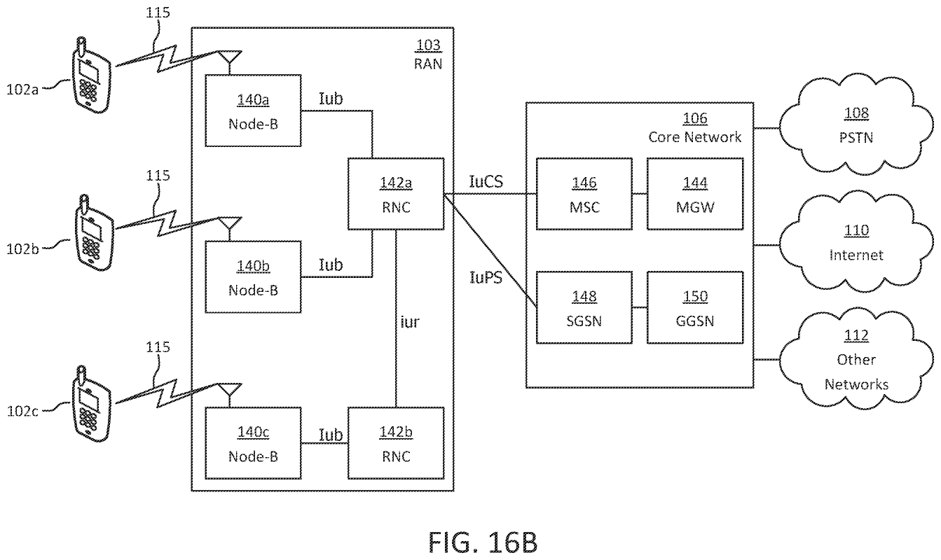

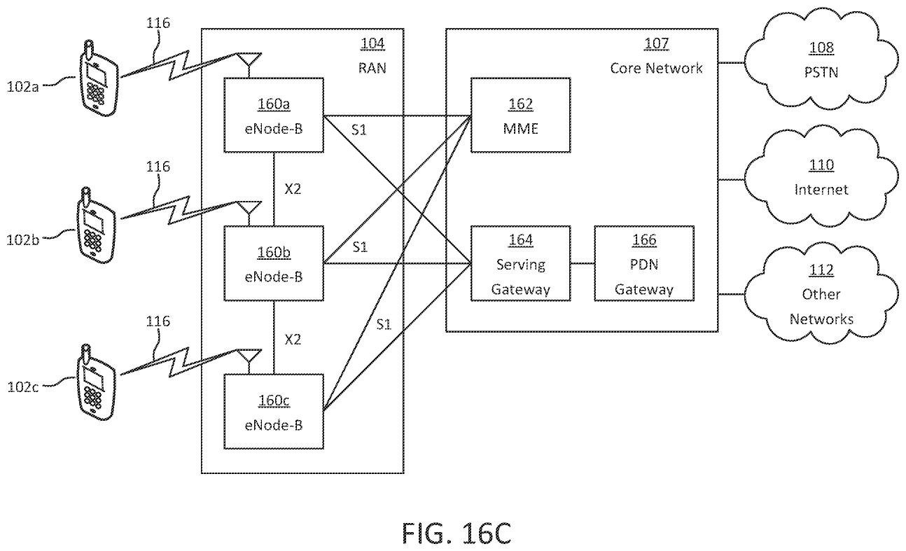

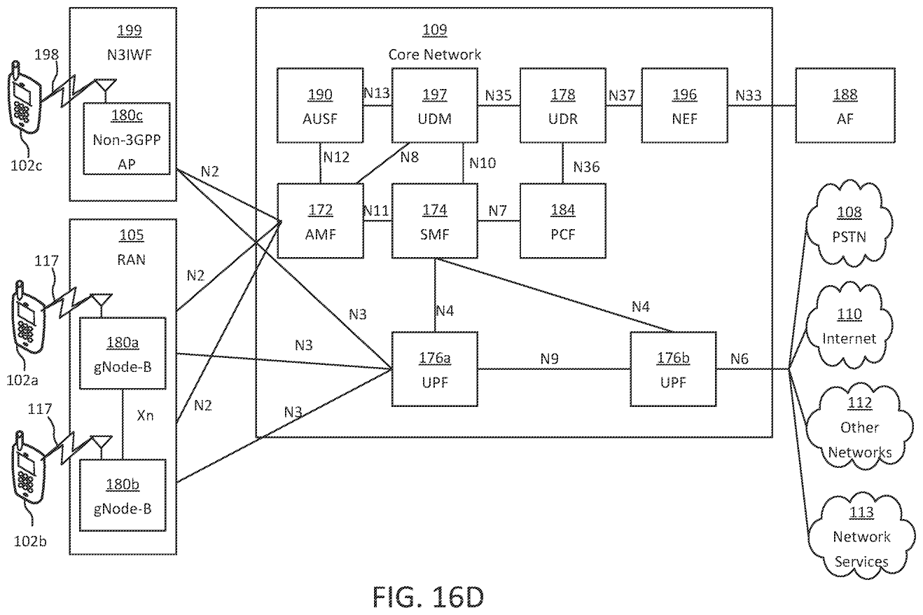

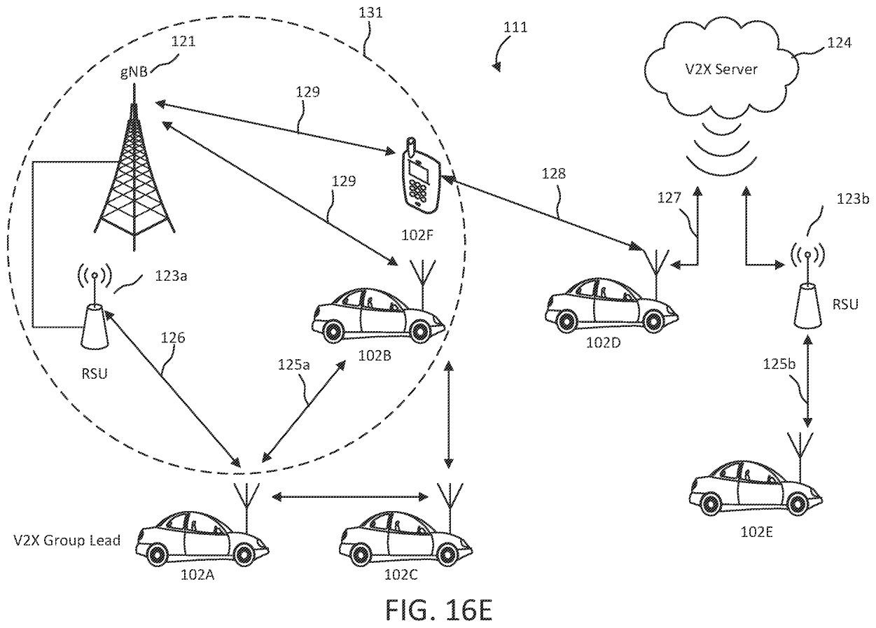

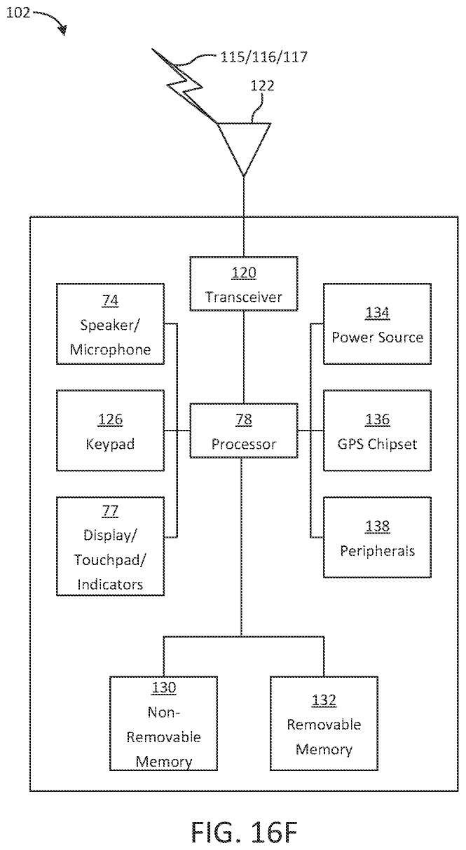

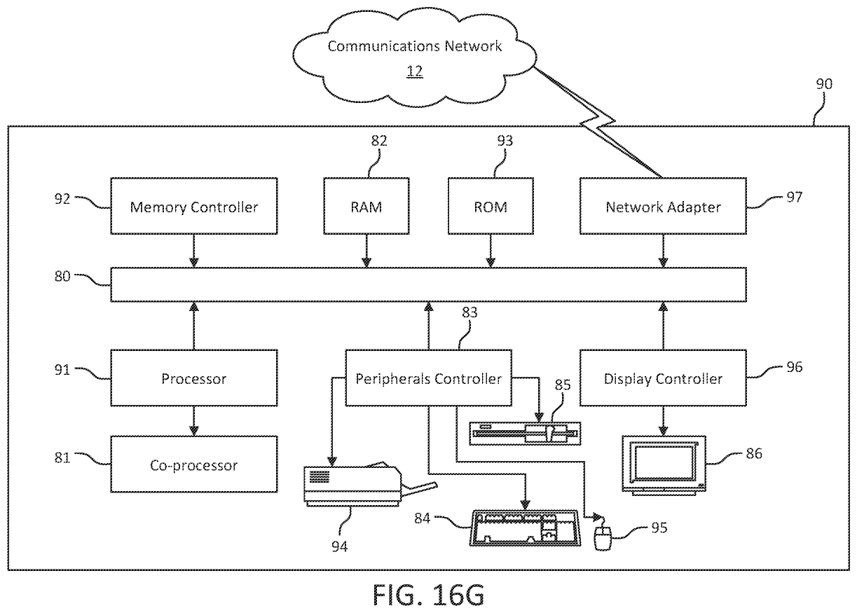

FIG. 2 illustrates an example communications system 50 in which the systems, methods, or apparatuses that implement NR SL operation in licensed or unlicensed spectrum, described herein, may be used. Communications system 50 (or other disclosed herein such as FIG. 16A-FIG. 16G) may include UEs 51 (e.g., TX UE 51a or RX UE 51b) or a base station 52. In practice, the concepts presented herein may be applied to any number of UEs 51, base station 52, V2X networks, or other network elements. Each UE 51 may perform the functions of an RX UE 51b or TX UE 51a.

There are multiple approaches disclosed herein.

To enable sidelink operation in unlicensed spectrum, one approach may be to allow a UE 51 share a COT with one or more other UEs 51. TX UE 51a may share a COT with one or more RX UEs 51b. TX UE 51a may also share the COT with one or more other TX UEs 51a. Similarly, an RX UE 51b may share a COT with one or more TX UEs 51a. RX UE 51b may also share a COT with one or more other RX UEs 51b. In one example, the sharing of a COT may be at the granularity level of a UE 51 (e.g., a COT shared between two peer UEs are valid to be used for any destination layer-2 ID or sidelink service). In another example, the sharing of a COT may be at the granularity level of destination layer-2 ID (e.g., a COT is shared between UEs only for specific destination layer-2 ID or sidelink service). Furthermore, the sharing of a COT may be at the granularity level of service type or transmission mode for example a COT may be shared between UEs 51 only for use by unicast transmission mode, or groupcast transmission mode, multicast transmission mode or alternatively only for use by broadcast transmission mode. It is understood herein, that while one option of the granularity of sharing of COT is expressed in terms of destination layer2-ID, COT sharing between two or more UEs 51 may also be performed at the granularity level of source layer-2 ID. Furthermore, a COT sharing between two or more UEs 51 may be performed at the granularity level of destination layer-1 ID or source layer-1 ID. A COT may be shared at the granularity level of resource type or physical channel type (e.g., data channel versus control channel), LBT type, or LBT category. Additionally, COT sharing may be performed at a granularity level that may include a combination of one or more of the options described above. A TX UE 51a may initiate a COT sharing. An RX UE 51b may initiate a COT sharing. In yet another alternative, a scheduling or controlling entity, such as a base station, gNB, a scheduling or controlling UE, or a scheduling or controlling RSU or the like may initiate a COT sharing, including performing LBT, acquiring the channel and then sharing the COT with one or more other UEs. A UE 51 may initiate the COT. For example, UE 51 may perform LBT and acquire COT for transmission if channel is idle. SL COT may be shared based on SL transmission gap, SL transmission duration, etc.

SL LBT parameters may be sent in SCI. LBT type or LBT category may be carried in SCI. Information regarding granularity of the sharing of the COT including how to use the shared COT and LBT may be carried in SCI. SL control or data channel may use one of LBT types or LBT categories. If such LBT type or LBT category is not needed for SL, then UE 51 may switch to another LBT type or LBT category. Such switch may be implicit or explicit.

To reduce power, a resource, resource pool, resource partition, resource pool partition, or the like may be indicated. If resource, resource pool, resource partition, or resource pool partition is occupied, then UE 51 may skip the monitoring of SCI or PSCCH for the indicated resource or partition. If resource, resource pool, resource partition, or resource pool partition is not occupied, then UE 51 may monitor for the SCI or PSCCH for the indicated resource or partition.

To further save power, UE 51 may be configured with two PSCCH monitoring modes. UE 51 may dynamically switch the PSCCH monitoring modes. UE 51 may switch the PSCCH monitoring modes using implicit switching or explicit switching. UE 51 may be configured with implicit or explicit switching for PSCCH monitoring mode.

To enhance reliability for SL feedback and reduce retransmission for SL, SL feedback pending indication may be used. TX UE 51a may send a SCI including SL feedback pending indication control field. If such SL control field indicates that UE feedback is pending, RX UE 51b may wait for next SCI and decode SCI to receive data accordingly. RX UE 51b may send the feedback (e.g., HARQ ACK/NACK for the current new data and previous data that are scheduled by SCI).

TX UE 51a may request RX UE 51b to retransmit UE feedback. SL feedback retransmission indication may be sent to RX UE (e.g., via SCI). If RX UE 51b receives feedback retransmission request, RX UE 51b may retransmit the UE feedback (e.g., HARQ ACK/NACK) back to TX UE 51a (e.g., via PSFCH). For example, RX UE 51b may retransmit the feedback for HARQ processors.

If LBT failure rate is low, then implicit ACK and explicit NACK may be used. If LBT failure rate is high, then explicit ACK and implicit NACK may be used. When LBT failure rate is low and implicit ACK and explicit NACK are used, a first SL timer may be configured. A first SL timer (timer 1) may start when a SL transport block is transmitted. If no explicit NACK is received before the SL timer expires, then ACK may be assumed. If explicit NACK is received, then transport block may be retransmitted to RX UE 51b.

When LBT failure rate is high and explicit ACK and implicit NACK are used, a second SL timer may be configured. A second SL timer (timer 2) may start when a SL transport block is transmitted. If no explicit ACK is received before the SL timer expires, then NACK may be assumed. SL transport block may be retransmitted to RX UE 51b. If explicit ACK is received before a second timer expires, then transport block is not needed to be retransmitted to RX UE 51b.

To reduce overhead for explicit ACK feedback, a sidelink ACK feedback indicator (SL-AFI) may be introduced. SL-AFI may be used to indicate the status of HARQ processes ACK or NACK. For example, a bitmap may be used for SL-AFI.

To enable sidelink operation in unlicensed spectrum, one approach may allow that a UE 51 may share the COT with one or more other UEs. TX UE 51a may share the COT with one or more RX UEs 51b. TX UE 51a may also share the COT with one or more other TX UEs 51a. Similarly, an RX UE 51b may share a COT with one or more TX UEs 51a. RX UE 51b may also share a COT with one or more other RX UEs 51b. A UE 51 may initiate the COT. If the gap between any two transmissions may be less than or equal to a predefined or (pre-)configured threshold, then the UE 51 that initiates the COT may continue the transmission without LBT. If the gap between the two transmissions is larger than a predefined or (pre-)configured threshold, then the UE 51 that initiates the COT may need to perform LBT before the transmission (e.g., the second transmission). Information regarding granularity of the sharing of the COT including how to use the shared COT and LBT may be carried in SCI.

If the gap between two transmissions, e.g., both from the TX UE 51a or one from the TX UE 51a and one from the RX UE 51b is less than or equal to a time threshold (say threshold 1), then the UE 51 who shares the COT may continue the transmission (e.g., the second transmission) without LBT. However, if duration of feedback (e.g., PSFCH) from RX UE 51b is larger than a time threshold (say threshold 2) (or larger than the remaining COT duration), then the UE 51 who shares the COT may perform LBT for the transmission even if the gap between two transmissions or between transmitted and received transmissions (e.g., between PSSCH and PSFCH) is less than or equal to a threshold (say threshold 2). If the gap between transmitted and received transmission is larger than a threshold (say threshold 1), then the UE 51 who shares the COT may perform LBT for the transmission. Multiple time thresholds may be predefined or (pre-)configured. For example, multiple thresholds (e.g., example threshold 1 or threshold 2) including multiple values of the same thresholds may be configured into the UE, for example on the basis of COT sharing granularity.

It may also be possible that no maximum SL gap (e.g., SL transmission gap) may be used or defined. A subsequent SL transmission or later SL transmission may share the SL COT without LBT with any SL transmission gap within the maximum SL COT duration. It may also be possible that a maximum SL gap may be used and defined. A subsequent SL transmission or a later SL transmission may share the SL COT without LBT only if the subsequent SL transmission or later SL transmission starts within maximum SL gap from the end of the previous SL transmission or earlier SL transmission. If the subsequent SL transmission or later SL transmission starts after maximum gap from the end of the previous SL transmission or earlier SL transmission, a short sensing, one shot sensing, aperiodic sensing, one-shot LBT or the like may be required to allow UEs to share the SL COT.

The approaches may also be applied to COT sharing between SL transmission and UL transmission. SL gap may also be predefined, configured or pre-configured. In addition, SL gap may also be indicated to UE 51 dynamically or semi-statically.

In one example, the sharing of a COT may be at the granularity level of a UE 51 (e.g., a COT shared between two peer UEs 51 are valid to be used for any destination layer-2 ID or sidelink service). In another example, the sharing of a COT may be at the granularity level of destination layer-2 ID (e.g., a COT is shared between UEs 51 only for specific destination layer-2 ID or sidelink service). Furthermore, the sharing of a COT may be at the granularity level of service type or transmission mode for example a COT may be shared between UEs only for use by unicast transmission mode, or groupcast transmission mode, multicast transmission mode or alternatively only for use by broadcast transmission mode. It is understood herein, that while one option of the granularity of sharing of COT is expressed in terms of destination layer2-ID, COT sharing between two or more UEs may also be performed at the granularity level of source layer-2 ID. Furthermore, a COT sharing between two or more UEs 51 may be performed at the granularity level of destination layer-1 ID or source layer-1 ID. A COT may be shared at the granularity level of resource type or physical channel type (e.g., data channel versus control channel), LBT type or LBT category. Additionally, COT sharing may be performed at a granularity level that consists of a combination of one or more of the options described above. A TX UE 51a may initiate a COT sharing. An RX UE 51b may initiate a COT sharing. In yet another alternative, a scheduling or controlling entity such as a base station, gNB, a scheduling or controlling UE, or a scheduling or controlling RSU or the like may initiate a COT sharing, including performing LBT, acquiring the channel and then sharing the COT with one or more other UEs. A UE 51 may initiate the COT. For example, UE 51 may perform LBT and acquire COT for transmission if channel is idle. SL COT may be shared based on SL transmission gap, SL transmission duration, etc.

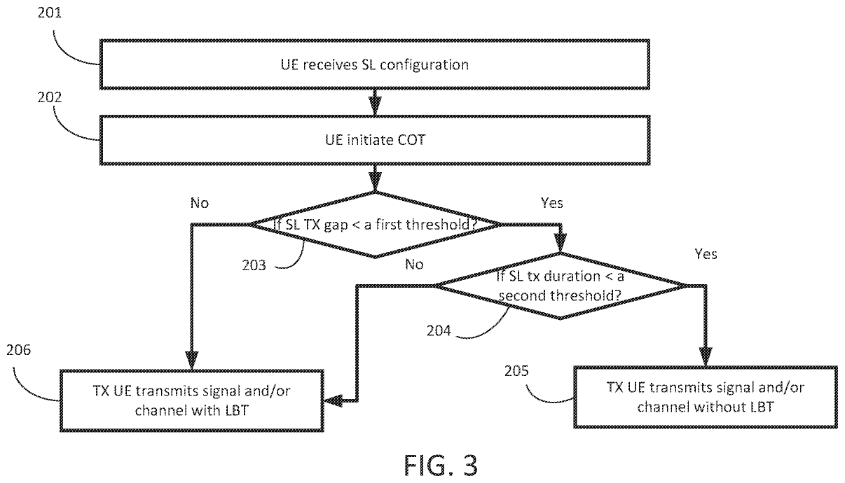

An example method of LBT conditions and procedures is depicted in FIG. 3. At step 201, UE 51 may receive SL configuration. Configuration may include one or more threshold configuration. At step 202, UE 51 may initiate COT. That is, UE 51 may perform LBT and acquire COT for transmission if channel is idle. At step 203, if SL transmission gap is less than a first threshold, then UE 51 may or may not perform LBT for the subsequent transmission depending on the transmission duration. At step 204, if transmission duration is less than a second threshold, then at step 205 TX UE 51a may transmit signal or channel (e.g., TB) without LBT. At step 204, if transmission duration is not less than a second threshold, then at step 206 TX UE 51a may transmit signal or channel with LBT. If at step 203 SL transmission gap is less than a first threshold, then at step 206 TX UE 51a may also transmit signal or channel with LBT.

If the gap (e.g., SL TX gap) between two transmissions or between transmitted and received transmissions is less than or equal to a time threshold (say threshold 3), then UE 51 may share the COT without LBT. If RX UE 51b initiates COT, then RX UE 51b may share the COT with TX UE 51a. Energy detection threshold may be configured for RX UE 51b. If energy detection threshold is configured, then TX UE 51a may transmit control or data, such as PSCCH or PSSCH with long duration. If energy detection threshold is not configured, then short duration of transmission for TX UE 51a may be possible. TX UE 51a may transmit signal or channel (e.g., SCI in PSCCH or SCI in PSSCH with short duration).

If the gap between two transmissions or between transmission and reception is larger than a time threshold (say threshold 3), then UE 51 (e.g., a TX UE 51a or a RX UE 51b) may share the COT with LBT.

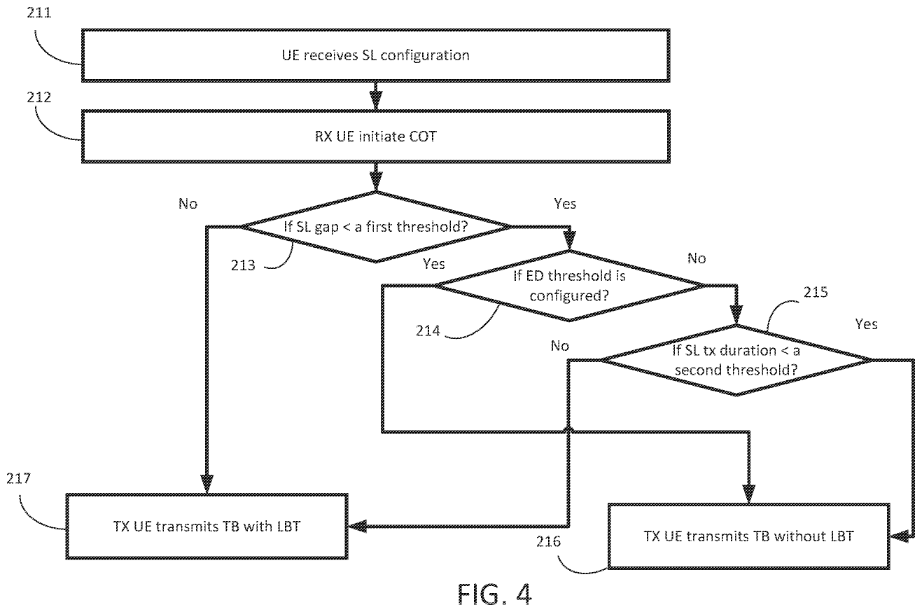

Method of COT, LBT conditions and procedures is depicted in FIG. 4. At step 211, UE 51 may receive SL configuration. At step 212, RX UE 51b may initiate COT. At step 213, if SL gap is less than a first threshold, then whether to perform LBT before transmission may depend on energy detection (ED) threshold and transmission duration. If energy detection threshold is configured (at step 214), then TX UE 51a may transmit signal or channel without LBT (at step 216). if energy detection threshold is not configured, then TX UE 51a may transmit signal or channel with or without LBT which may depend on transmission duration. If SL transmission duration is less than a second threshold (at step 215), then at step 216 TX UE 51a may transmit signal or channel without LBT. If SL transmission duration is not less than a second threshold (at step 215), then at step 217 TX UE 51a may transmit signal or channel with LBT. If SL transmission gap is not less than a first threshold (at step 213), then at step 217 TX UE 51a may transmit signal or channel with LBT.

Certain signal(s) or channel(s) may be sent with or without LBT. This may be based on the transmission gap. This may also be based on some predefined conditions. For example, PSCCH may be sent but PSSCH may not be sent or PSFCH may be sent but PSCCH/PSSCH may not be sent if LBT is not performed. This may also be based on whether energy detection threshold is configured or not.

SL LBT parameters may be sent in SCI (e.g., 1^{st} stage SCI or 2^{nd} stage SCI). LBT type or LBT category may be carried in SCI. Information regarding granularity of the sharing of the COT including how to use the shared COT and LBT may be carried in SCI. SL control or data channel may use one of LBT types or LBT categories. If such LBT type or LBT category is not needed for SL, then UE 51 may switch to another LBT type or LBT category. Such switch may be implicit or explicit.

For SL explicit approach, indication with explicit bit(s) may be used to indicate the switch. For example, if indication is set to “0”, then UE 51 may switch to LBT type 1. If indication is set to “1”, then UE 51 may switch to LBT type 2.

SL COT duration may be indicated. For implicit approach, UE 51 may switch to another LBT type or LBT category if SL COT duration field is not configured. UE 51 may switch to another LBT type or LBT category based on the COT duration that is indicated in SL slot format indicator (SL-SFI) field. UE 51 may switch to another LBT type or LBT category if SL COT duration field is configured. UE 51 may switch to another LBT type or LBT category based on the COT duration indicated in SL COT duration field. A default LBT type or default LBT category for SL may be used.

If SL COT duration is not provided, the remaining SL channel occupancy duration may be a number of slots that the SL-SFI index field value provides corresponding SL slot formats. The remaining channel occupancy duration may be a number of SL slots starting from the slot where the UE 51 may detect the SCI format. A SL-SFI index field value in a SCI format may indicate to a UE 51 a slot format for each SL slot in a number of slots starting from a slot where the UE 51 may detect the SCI format. The number of slots may be equal to or larger than a PSCCH monitoring periodicity for SCI format.

Multiple LBT Categories and multiple LBT types may be used. For example, LBT Category 2 may be LBT Type 2A and LBT Type 2B. UE 51 may sense the channel for a fixed time duration. If the channel remains idle during the sensing period, the UE 51 may access the channel. LBT Category 4 may be LBT Type 1. UE 51 may back off according to the sensing procedure. LBT Category 1 may be LBT Type 2C. A base station 52 may access the channel immediately without performing LBT. The COT may be up to a maximum duration.

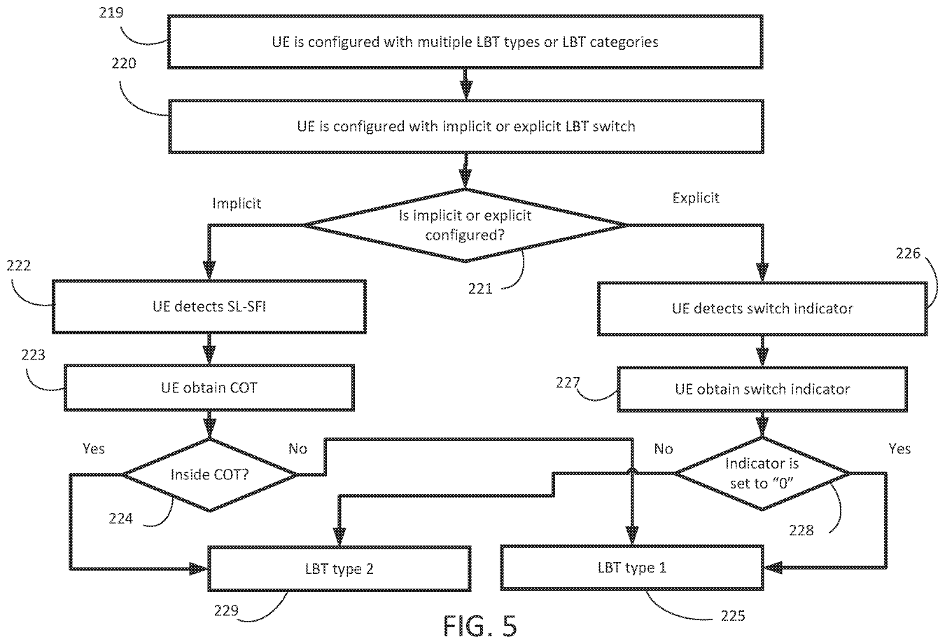

Method of LBT type indication and switching procedure is depicted in FIG. 5. At step 219, UE 51 may be configured or preconfigured with multiple LBT types or LBT categories. At step 220, UE 51 may be also configured with implicit or explicit LBT switch. If explicit LBT switch is configured at step 221, then at step 226 UE 51 may monitor LBT switch indicator. At step 227, UE 51 may obtain the value of indicator. If LBT indicator is set to “0” at step 228, then at step 225 LBT type 1 is indicated. If LBT indicator is set to “1” at step 228, then at step 229 LBT type 2 is indicated.

If implicit LBT switch is configured at step 221, then at step 222 UE 51 may monitor SL-SFI. At step 223, UE 51 may detect and obtain COT. If it is inside the COT at step 224, then at step 229 UE 51 may perform LBT type 2 for transmission. If it is not inside the COT (or it is outside the COT) at step 224, then at step 225 UE 51 may perform LBT type 1 for transmission.

To reduce power consumption, a resource, resource pool, resource partition, resource pool partition, or the like may be indicated. RX UE 51b may be indicated by TX UE 51a. If resource, resource pool, resource partition, resource pool partition is occupied, then UE 51 may skip the monitoring of SCI or PSCCH for the indicated resource or partition. If resource, resource pool, resource partition, resource pool partition is not occupied, then UE 51 may monitor for the SCI or PSCCH for the indicated resource or partition. UE 51 may decode PSSCH accordingly based on the decoded SCI or PSCCH. A bitmap may be used for indication. For example, if a resource, resource pool, resource partition, resource pool partition is occupied, then a corresponding bit is set to “1”, otherwise the corresponding bit is set to “0”. Indication for a resource, resource pool, resource partition, resource pool partition may be carried in SCI, e.g., the 1^{st} stage SCI or the 2^{nd} stage SCI. Indication for a resource, resource pool, resource partition, resource pool partition may be carried in PSCCH or PSSCH. Indication for a resource, resource pool, resource partition, resource pool partition may be carried in a group common PSCCH, group common PSSCH, or via groupcast or broadcast. SL-SFI may be used.

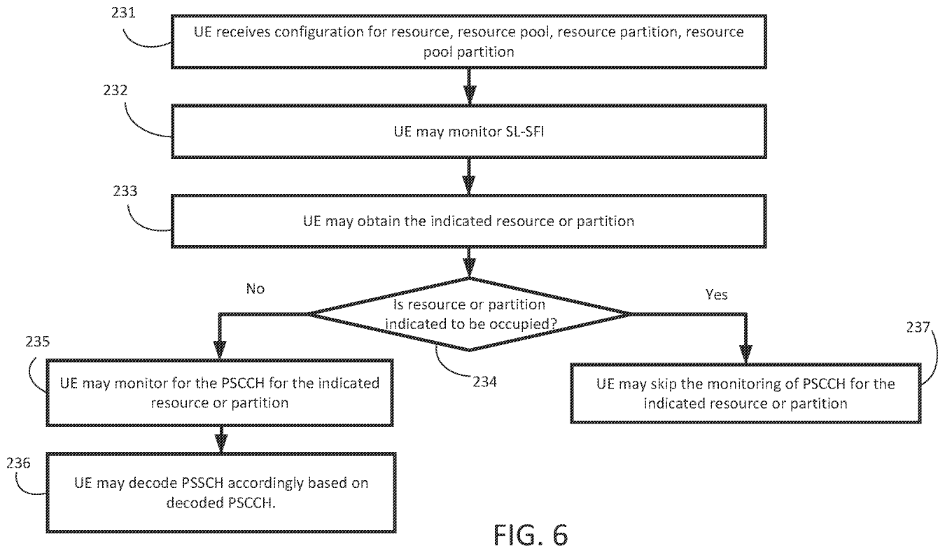

Method of method of resource or partition indication for PSCCH monitoring (e.g., SL-SFI) is depicted in FIG. 6.

At step 231, UE 51 may receive configuration for resource, resource pool, resource partition, or resource pool partition. At step 232, UE 51 may monitor SL-SFI. At step 233, UE 51 may obtain the indicated resource, resource pool, resource partition, or resource pool partition. At step 234, if the resource, resource pool, resource partition, or resource pool partition is indicated to be occupied, then at step 237 UE 51 may skip PSCCH monitoring for the indicated resource, resource pool, resource partition, or resource pool partition. If the resource, resource pool, resource partition or resource pool partition is indicated to be not occupied at step 234, then at step 235 UE 51 may monitor PSCCH for the indicated resource, resource pool, resource partition or resource pool partition. At step 236, UE 51 may decode PSSCH accordingly based on the decoded PSCCH.

To further save power, UE 51 may be configured with two PSCCH monitoring modes. One PSCCH monitoring mode may be more frequent for monitoring PSCCH while the other PSCCH monitoring mode may be less frequent for monitoring PSCCH. UE 51 may dynamically switch the PSCCH monitoring modes. UE 51 may switch the PSCCH monitoring modes using implicit switch or explicit switching. UE 51 may be configured with implicit or explicit switching for PSCCH monitoring mode.

If UE 51 may be configured with explicit PSCCH monitoring mode switching, UE 51 may switch to one of PSCCH monitoring modes based on indication (e.g., received from TX UE), e.g., if PSCCH monitoring mode 1 is indicated, then UE 51 switch to mode 1. If mode 2 is indicated, then UE 51 switch to mode 2. In addition, UE 51 may be configured with a PSCCH timer. UE 51 may switch back to mode 1 from mode 2 if PSCCH timer expires. UE 51 may switch back to mode 1 from mode 2 if it is end of SL COT duration.

If UE 51 is configured with implicit PSCCH monitoring mode switching, UE 51 may switch to one of PSCCH monitoring modes based on timer or based on end of COT. For example, PSCCH monitoring mode 1 may be set or configured as default. UE 51 may switch to mode 2 if UE 51 detects SL COT. UE 51 may be configured with a PSCCH timer. UE 51 may switch back to mode 1 from mode 2 if PSCCH timer expires or at end of SL COT duration.

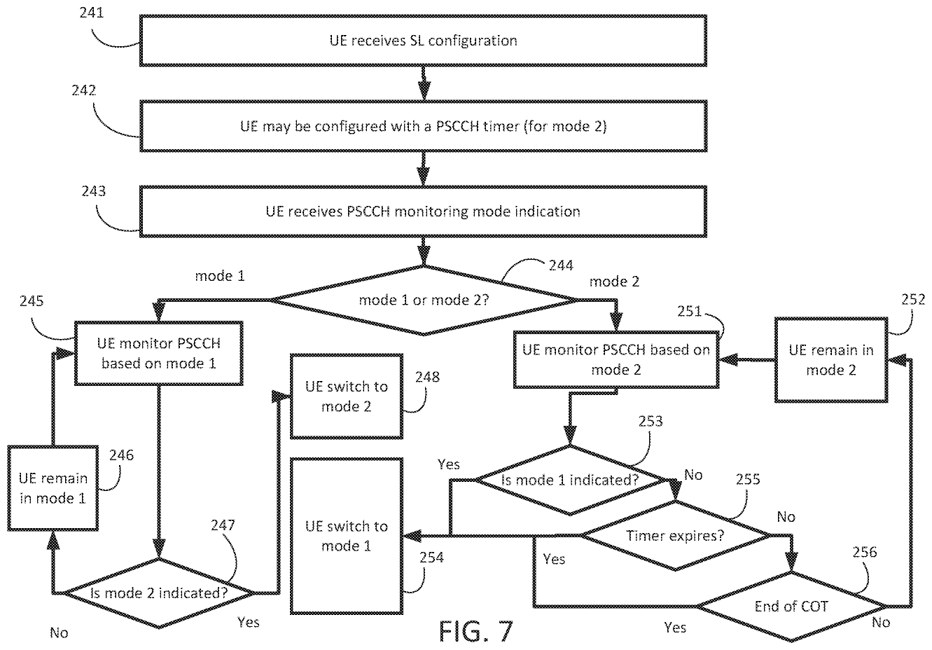

Method of PSCCH monitoring for power saving is depicted in FIG. 7. At step 241, UE 51 may receive SL configuration. At step 242, UE 51 may be configured with a PSCCH timer. For example, a PSCCH timer may be configured for PSCCH monitoring mode 2. At step 243, UE 51 may receive PSCCH monitoring mode indication. If PSCCH monitoring mode indication is “mode 1” at step 244, then at step 245 UE 51 may monitor PSCCH based on mode 1. At step 246, UE 51 may remain in mode 1 unless UE 51 receives PSCCH monitoring mode indication for “mode 2” at step 247. If, so, at step 248 UE 51 may switch to PSCCH monitoring mode 2.

If PSCCH at step 244 monitoring mode indication is “mode 2”, at step 251 UE 51 may monitor PSCCH based on mode 2. If PSCCH monitoring mode 1 is indicated at step 253, then at step 254 UE 51 may switch to mode 1. Otherwise, SL may remain in mode 2 at step 252. If PSCCH timer expires at step 255, then at step UE 51 may switch to PSCCH monitoring mode 1 at step 254. If not at step 255, then at step 252 UE 51 may remain in PSCCH monitoring mode 2 until the end of SL COT. If it is end of SL COT at step 256, then at step 254 UE 51 may switch to PSCCH monitoring mode 1. At step 256, if it is not end of SL COT, then at step 252 UE 51 may remain in PSCCH monitoring mode 2.

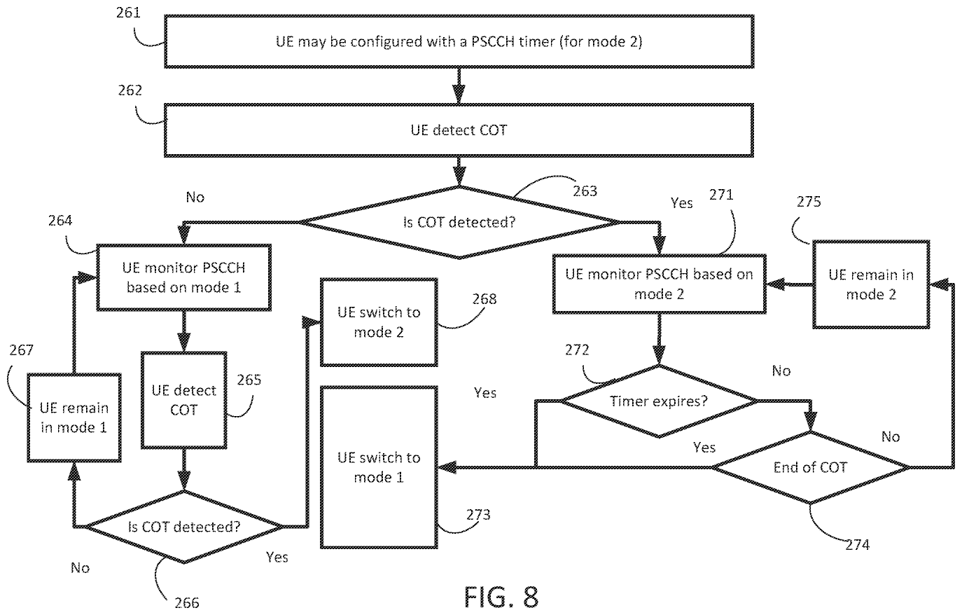

Method of PSCCH monitoring (implicit) for power saving is depicted in FIG. 8. At step 261, UE 51 may be configured with PSCCH timer for example for PSCCH monitoring mode 2. At step 262, UE 51 may detect SL COT. At step 263, if SL COT is detected, then at step 271 UE 51 may monitor PSCCH based on PSCCH monitoring mode 2. At step 272, if PSCCH timer expires, then at step 273 UE 51 may switch to PSCCH monitoring mode 1. Otherwise, at step 264 UE 51 may remain in PSCCH mode 1. At step 274, if it is end of COT, then at step 273 UE 51 may switch to PSCCH monitoring mode 1. Otherwise, at step 275 UE 51 may remain in PSCCH mode 2. At step 271, UE 51 may continue monitoring PSCCH based on PSCCH monitoring mode 2.

At step 263 SL COT is not detected, then at step 264 UE 51 may monitor PSCCH based on PSCCH monitoring mode 1. At step 265, UE 51 may continue detecting COT. At step 266, if SL COT is detected, then at step 266 UE 51 may switch to PSCCH monitoring mode 2. Otherwise, at step 267 UE 51 may remain in PSCCH monitoring mode 1. At step 264, UE 51 may monitor PSCCH based on PSCCH monitoring mode 1.

Indication of PSCCH monitoring mode may be carried in SCI. Indication of PSCCH monitoring mode may be carried in PSCCH. One of PSCCH monitoring modes may be set or (pre-)configured by default.

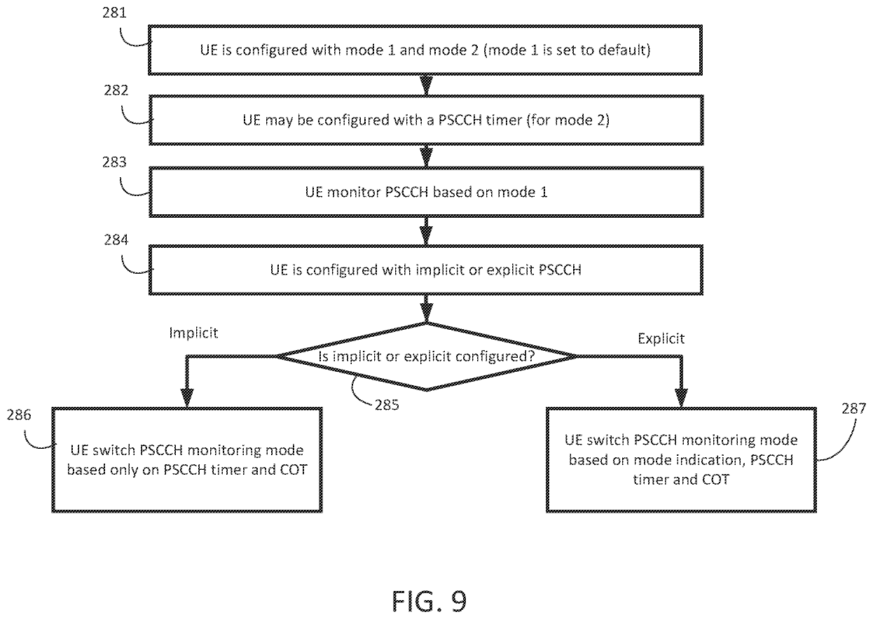

Method of PSCCH monitoring switching with default mode is depicted in FIG. 9. At step 281, UE 51 may be configured with PSCCH monitoring mode 1 and mode 2. PSCCH monitoring mode 1 may be set as default as example. At step 282, UE 51 may be configured with a PSCCH timer. For example, a PSCCH timer may be configured for PSCCH monitoring mode 2. At step 283, UE 51 may monitor PSCCH based on PSCCH monitoring mode 1. At step 284, UE 51 may be configured with implicit or explicit PSCCH monitoring mode switch. At step 285, if explicit PSCCH monitoring mode switch is configured, then at step 287 UE 51 may switch PSCCH monitoring mode based on PSCCH monitoring mode indication, PSCCH timer and COT. At step 286, if implicit PSCCH monitoring mode switch is configured, then at step 286 UE 51 may switch PSCCH monitoring mode based only on PSCCH timer and COT.

Indication of PSCCH monitoring mode may be carried in SCI e.g., the 1^{st} stage SCI, the 2^{nd} stage SCI, PSCCH or PSSCH. Indication of PSCCH monitoring mode may be included in SCI format 1A, SCI format 2A, SCI format 2B, or a new SCI format, e.g., SCI format 1X, SCI format 2Y, SCI format 3_Z, or the like.

To enhance reliability for SL feedback and reduce retransmission for SL, SL feedback pending indication may be used. TX UE 51a may send a SCI including SL feedback pending indication control field. If such SL control field indicates that UE feedback is pending, RX UE 51b may wait for next SCI and decode SCI to receive data accordingly. This may be used when remaining COT is small. UE 51 may send the feedback e.g., HARQ ACK/NACK for the current new data and previous data that are scheduled by SCI. TX UE 51a may send a SCI including a SL feedback timing indication control field. SL feedback timing indication control field indicates when to transmit the UE feedback, e.g., HARQ ACK/NACK. If SL feedback pending control field is not configured, RX UE 51b may wait for retransmission of data from TX UE. If SL feedback timing indication control field is not configured, RX UE 51b may determine the SL feedback timing based on location of PSCCH, PSSCH or combination of them. SL feedback timing indication control field may indicate one or more feedback timings. Number of SL feedback timings may be configurable. Both SL feedback pending indication and SL feedback timing indication may be configurable by TX UE, group manager, group leader, scheduling UE, base station, or the like.

SL feedback pending indication or SL feedback timing indication may be configurable in SCI format. If configured, SL feedback pending indication or SL feedback timing indication may be included in SCI format 1A, SCI format 2A, SCI format 2B. SL feedback pending indication or SL feedback timing indication may be carried in new SCI format, e.g., SCI format 1X, new SCI format 2Y, new SCI format 3Z, or the like.

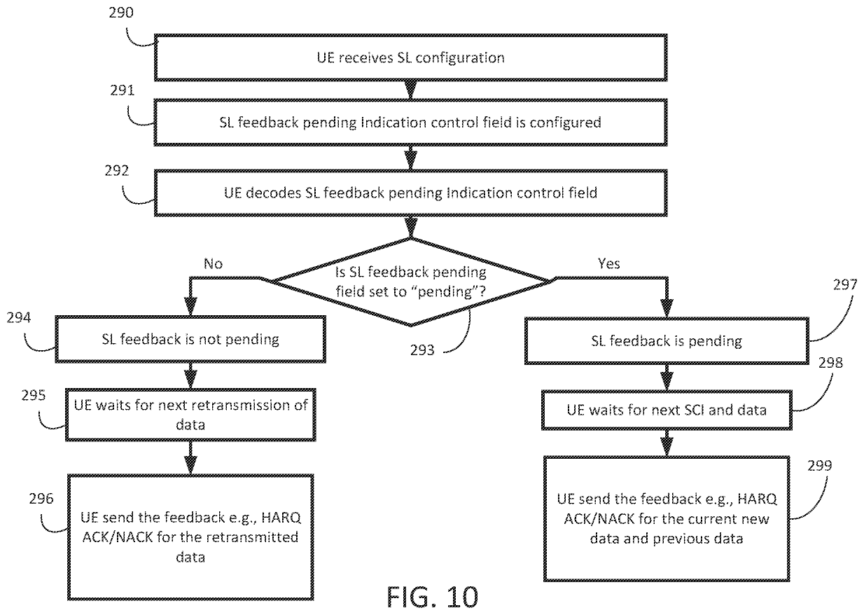

Method of SL feedback pending indication is depicted in FIG. 10. At step 290, UE 51 may receive SL configuration. At step 291, SL feedback pending indication may be introduced. At step 292, SL feedback pending indication control field may be configured. UE 51 may monitor and decode SL feedback pending indication control field. At step 293, if SL feedback pending indication control field is set to “1” or “pending”, then at step 297 SL feedback pending is indicated. At step 298, UE 51 may wait for next SCI and data to decode. At step 299, UE 51 may send the feedback, e.g., HARQ ACK/NACK for the current new data and previous data. At step 293, if SL feedback pending indication control field is set to “0” or “not pending”, then at step 294 SL feedback pending is not indicated. At step 295, UE 51 may wait for next retransmission of data to decode. At step 296, UE 51 may send the feedback, e.g., HARQ ACK/NACK for the retransmitted data.

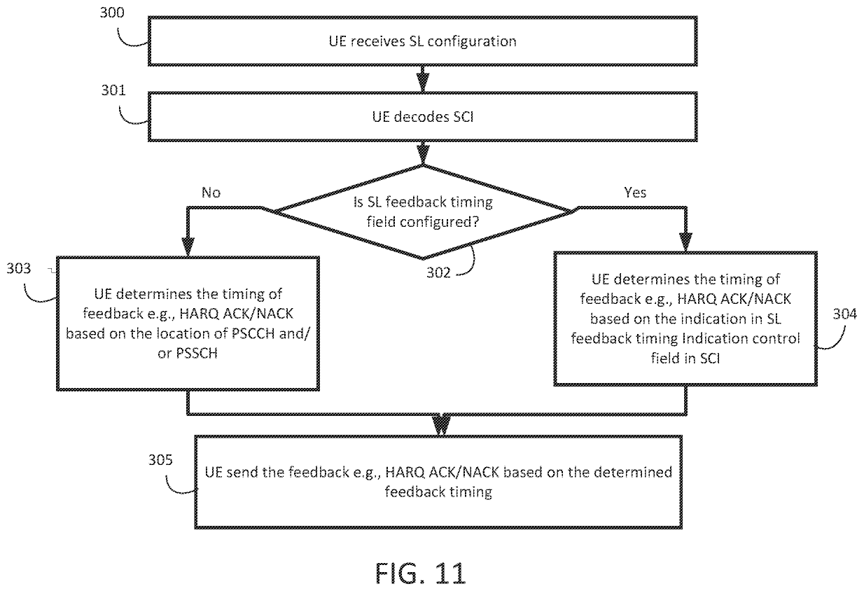

Method of SL feedback timing procedure is depicted in FIG. 11. At step 300, UE 51 may receive SL configuration. At step 301, UE 51 may monitor and decode SCI. At step 302, if SL feedback timing control field is configured, then at step 304 UE 51 may determine the timing of feedback, e.g., HARQ ACK/NACK, based on the indication in SL feedback timing indicator control field, e.g., in SCI. At step 302, if SL feedback timing control field is not configured, then at step 303 UE 51 may determine the timing of feedback, e.g., HARQ ACK/NACK, based on the location of PSCCH or PSSCH. At step 305, UE 51 may send the feedback, e.g., HARQ ACK/NACK, based on the determined feedback timing. The location of PSCCH or PSSCH may be in frequency or time.

TX UE 51a may request RX UE 51b to retransmit UE feedback. SL feedback retransmission indication may be sent to RX UE 51b, e.g., via SCI. If RX UE 51b receives feedback retransmission request, RX UE 51b may retransmit the UE feedback, e.g., HARQ ACK/NACK, back to TX UE 51a, e.g., via PSFCH. For example, RX UE 51b may retransmit the feedback for HARQ processors.

SL feedback retransmission indication may be configurable in SCI format. If configured, SL feedback retransmission indication may be included in SCI format 1A, SCI format 2A, SCI format 2B. SL feedback retransmission indication may be carried in new SCI format, e.g., new SCI format 1X, new SCI format 2Y, new SCI format 3Z, or the like.

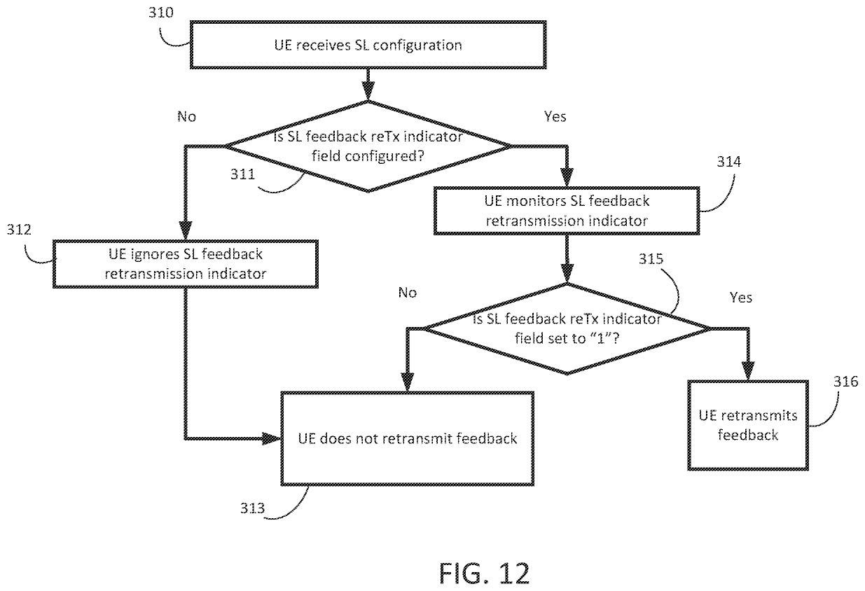

Method of SL feedback retransmission procedure is depicted in FIG. 12. At step 310, UE 51 may receive SL configuration. At step 311, if SL feedback retransmission indication control field is configured, then at step 314 UE 51 may monitor SL feedback retransmission indicator. At step 315, if SL feedback retransmission indicator control field is set to “1”, then SL feedback retransmission is requested, then at step 316 UE 51 may retransmit the feedback, e.g., HARQ ACK/NACK. For example, UE 51 may retransmit the feedback for HARQ ACK/NACK in PSFCH, PSSCH or PSCCH. At step 315, if SL feedback retransmission indicator control field is set to “0”, then SL feedback retransmission is not requested, at step 313 then UE 51 may not retransmit the feedback, e.g., HARQ ACK/NACK. At step 311, if SL feedback retransmission indication control field is not configured or SL feedback retransmission indication is not configured, then at step 312 UE 51 may not monitor SL feedback retransmission indication. UE 51 may request HARQ feedback (e.g., for all HARQ processes) to be retransmitted from another UE or a RX UE, a group of UEs, or the like.

If LBT failure rate is low, then implicit ACK and explicit NACK may be used. If LBT failure rate is high, then explicit ACK and implicit NACK may be used. When LBT failure rate is low and implicit ACK and explicit NACK are used, a first SL timer may be configured. A first SL timer (timer 1) may start when a SL transport block is transmitted. If no explicit NACK is received before the SL timer expires, then ACK may be assumed. If explicit NACK is received, then transport block may be retransmitted to RX UE.

When LBT failure rate is high and explicit ACK and implicit NACK are used, a second SL timer may be configured. A second SL timer (timer 2) may start when a SL transport block is transmitted. If no explicit ACK is received before the SL timer expires, then NACK may be assumed. SL transport block may be retransmitted to RX UE. If explicit ACK is received before a second timer expires, then transport block is not needed to be retransmitted to RX UE.

A threshold may be configured for LBT failure rate by TX UE, group manager, group leader, gNB or the like, and LBT failure rate or the like may be measured against a threshold to determine LBT failure rate is high or low.

The condition for LBT failure rate is low may be replaced with channel is not very busy or the like while condition for LBT failure rate is high may be replaced with channel is very busy or the like.

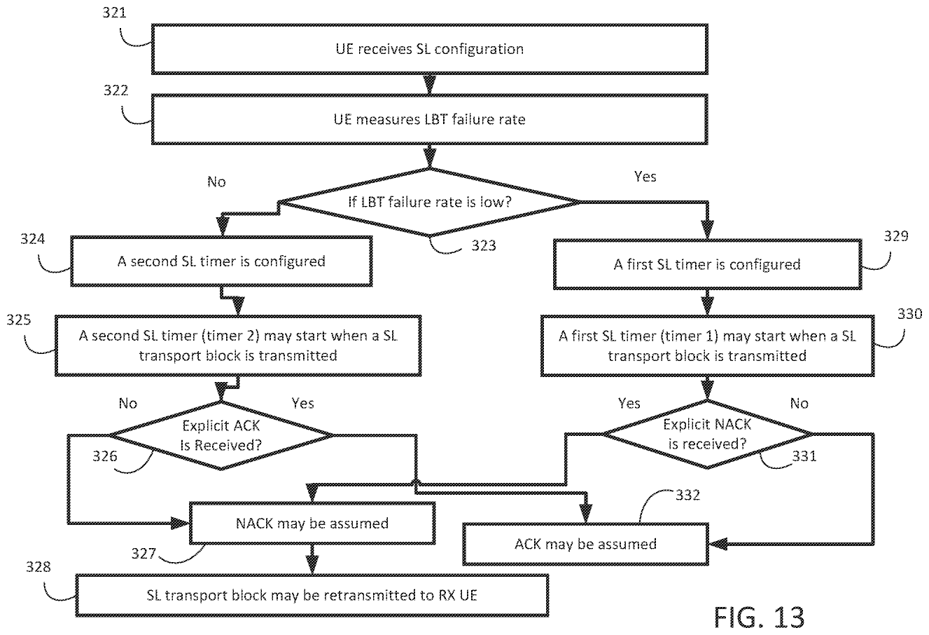

Method of SL retransmission procedures is depicted FIG. 13. At step 321, UE 51 may receive SL configuration. At step 322, UE 51 may measure LBT failure rate. At step 323 LBT failure rate is low (e.g., below a defined threshold), then at step 329 a first SL timer is configured. At step 330, a first SL timer (Say timer 1) may start when a SL transport block is transmitted. At step 331, if explicit NACK is received, then at step 327 NACK may be assumed. At step 328, SL transport block may be retransmitted to RX UE. At step 331, if explicit NACK is not received, then at step 332 ACK may be assumed.

At step 323, if LBT failure rate is high or not low (e.g., compare against a threshold), then at step 324 a second SL timer is configured. At step 325, second SL timer (Say timer 2) may start when a SL transport block is transmitted. at step 326, if explicit ACK is received, then at step 332 ACK may be assumed. At step 326, if explicit ACK is not received, then at step 327 NACK may be assumed. At step 328, SL transport block may be retransmitted to RX UE. A threshold may be (pre-)configured for LBT failure rate.

To reduce overhead for explicit ACK feedback, a sidelink ACK feedback indicator (SL-AFI) may be introduced. SL-AFI may be used to indicate the status of HARQ processes, such as ACK or NACK. For example, a bitmap may be used for SL-AFI. RX UE 51b may transmit SL-AFI. TX UE 51a may monitor SL-AFI. RX UE 51b may transmit SL-AFI corresponding to HARQ processes (e.g., configured HARQ processes or scheduled HARQ processes). If bit is set to “1”, then the corresponding HARQ process status is “ACK”. If bit is set to “0”, then the corresponding HARQ process status is “NACK”. Only HARQ process with NACK status may retransmit the PSSCH or TB from TX UE 51a. HARQ ACK/NACKs may be carried in SL-AFI bitmap. The bitmap size may be configurable.

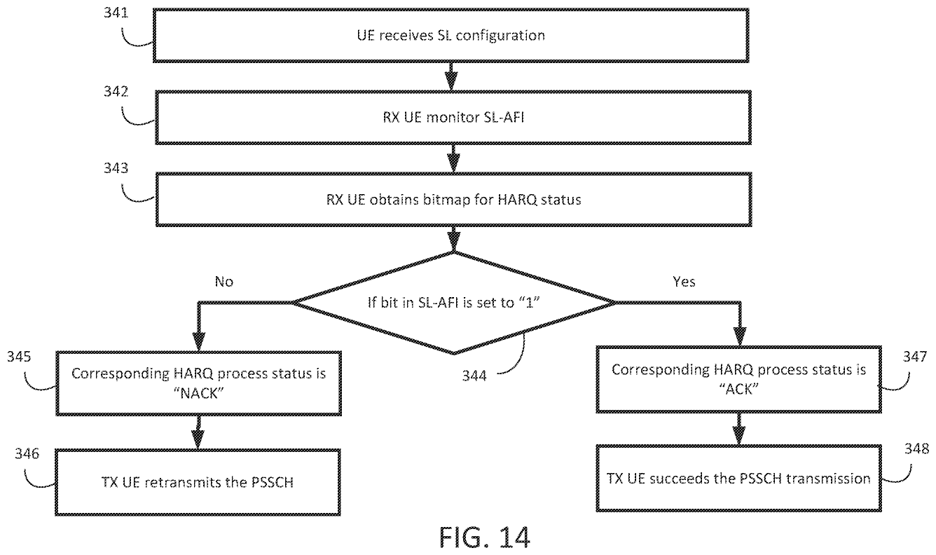

Method of SL SL-AFI procedures is depicted in FIG. 14. At step 341, UE 51 may receive SL configuration. At step 342, RX UE 51b may monitor SL-AFI. At step 343, RX UE 51b may obtain bitmap for HARQ status according to received SL-AFI. At step 344, if bit in SL-AFI is set to “1”, then at step 347 the corresponding HARQ process status may be ACK. At step 348, TX UE 51a may succeed the transmission or retransmission may not be performed. At step 344, if bit in SL-AFI is set to “0”, then at step 345 the corresponding HARQ process status may be NACK. At step 346, TX UE 51a may fail the transmission and retransmission may be performed. PSSCH may be retransmitted.

A WTRU (e.g., UE 51) may be indicated to receive explicit ACK, explicit NACK, or SL-AFI. For example, a UE 51 may be indicated to receive explicit ACK, explicit NACK, or SL-AFI based on channel condition(s), certain criteria or the like. Similarly, UE51 may be indicated to transmit explicit ACK, explicit NACK, or SL-AFI. Whether to transmit explicit ACK, explicit NACK, or SL-AFI may also be based on channel condition(s), certain criteria or the like. The terms WTRU and UE may be used interchangeably herein.

A UE, a group manager, a group leader, gNB, RSU or the like may indicate to the UE 51 that SL connection is operating in LBT mode or no-LBT mode. The LBT mode may be common or the same for a group of UEs or for some or all the UEs in a coverage area or in a cell. A group-specific or cell-specific LBT mode indication may be used to indicate to UE 51 the LBT mode that may be used. A group-specific common indication of LBT mode may be for UEs in a group or in a coverage area, and an area-specific or a cell-specific common indication of LBT mode may be for UEs in a coverage area or in a cell. This indication or information may be carried in group common control signaling or channel, broadcast signaling or channel, system information or dedicated RRC signaling or combination of them. The UE-specific LBT mode may also be used for individual UE. LBT mode may be different for different UEs. LBT mode indication may be carried in UE-specific RRC configuration or UE-specific control, signaling, data or channel.

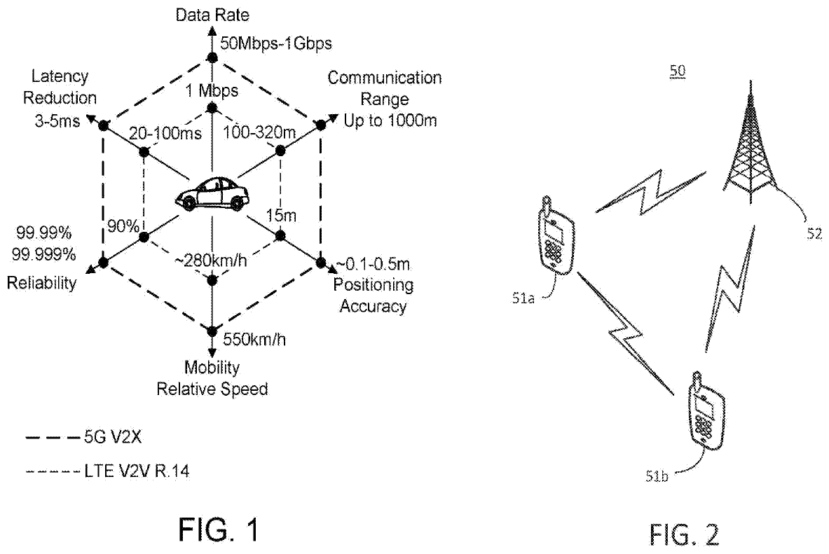

Contention Exempt Short Control Signaling rules apply to the SL transmission of SL control, signaling, channel or data for supported SL SCS. Restriction for short control signaling transmissions may apply. For example, the ten percentage over any 100 ms interval restriction may be applicable to available SL resources configured in a coverage area or a cell. The ten percentage over any 100 ms interval restriction may also be applicable to the SL transmission from the perspective of a UE 51. It is understood that the entities performing the steps illustrated herein, such as FIG. 1-FIG. 14, may be logical entities. The steps may be stored in a memory of, and executing on a processor of, a device, server, or computer system such as those illustrated in FIG. 16F or FIG. 16G. Skipping steps, combining steps, or adding steps between exemplary methods disclosed hercin (e.g., FIG. 1-FIG. 14) is contemplated. Table 1 illustrates exemplary abbreviations or definitions.

TABLE 1
Abbreviations and Definitions

| Abbreviations | Definitions |
|---|---|
| ACK | ACKnowledgement |
| BWP | Bandwidth Part |
| CC | Component Carrier |
| CCG | Component Carrier Group |
| CE | Control Element |
| CRC | Cyclic Redundancy Check |
| CSI | Channel State Information |
| DCI | Downlink Control Information |
| DMRS | DeModulation Reference Signal |
| DL | Downlink |
| HARQ | Hybrid Automatic Repeat Request |
| IE | Information Element |
| LTE | Long Term Evolution |
| MAC | Medium Access Control |
| MIB | Master Information Block |
| NACK | Non-ACKnowledgement |
| NR | New Radio |
| PIR | Packet Inter-Reception |
| PRB | Physical Resource Block |
| PRR | Packet Reception Ratio |
| PSBCH | Physical Sidelink broadcast Channel |
| PSCCH | Physical Sidelink Control Channel |
| PSFCH | Physical Sidelink Feedback Channel |
| PSSCH | Physical Sidelink Shared Channel |
| QoS | Quality of Service |
| RAN | Radio Access Network |
| RB | Resource Block |
| RBG | Resource Block Group |
| RNTI | Radio Network Temporary Identifier |
| RRC | Radio Resource Control |
| RSRP | Reference Signal Receive Power |
| RSU | Road Side Unit |
| S-SSB | Sidelink Synchronization Signal Block |
| S-RSRP | Sidelink Reference Signal Receive Power |
| S-RSSI | Sidelink Received Signal Strength Indicator |
| SCI | Sidelink Control Information |
| SFI | Slot Format Indicator |
| SI | System Information |
| SINR | Signal to Interference and Noise Ratio |
| SL | Sidelink |
| SNR | Signal to Noise Ratio |
| TB | Transport Block |
| UE | User Equipment |
| UL | Uplink |
| V2V | Vehicle-to-Vehicle |
| V2X | Vehicle-to-everything |

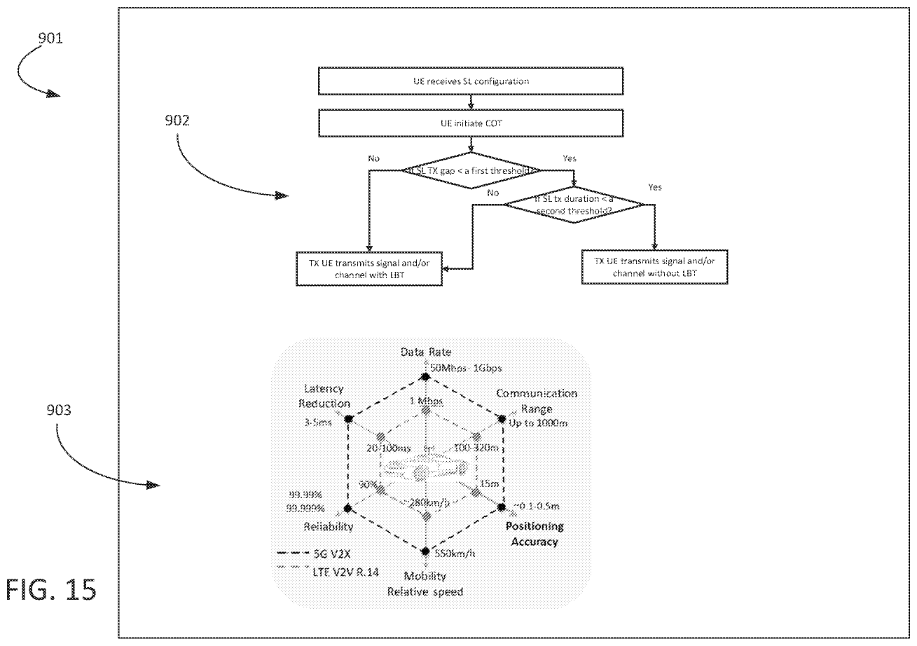

FIG. 15 illustrates an exemplary display (e.g., graphical user interface) that may be generated based on the methods, systems, and devices of NR SL operation in licensed or unlicensed spectrum, as discussed herein. Display interface 901 (e.g., touch screen display) may provide text in block 902 associated with NR SL operation in licensed or unlicensed spectrum conditions. Progress of any of the steps (e.g., sent messages or success of steps) discussed herein may be displayed in block 902. In addition, graphical output 902 may be displayed on display interface 901. Graphical output 903 may be the topology of the devices implementing the methods, systems, and devices of NR SL operation in licensed or unlicensed spectrum, a graphical output of the progress of any method or systems discussed herein, or the like.

The 3rd Generation Partnership Project (3GPP) develops technical standards for cellular telecommunications network technologies, including radio access, the core transport network, and service capabilities-including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 6 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mm Wave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

FIG. 16A illustrates an example communications system 100 in which the methods and apparatuses of NR SL operation in licensed or unlicensed spectrum, such as the systems and methods illustrated in FIG. 1 through FIG. 14 described and claimed herein may be used. The communications system 100 may include wireless transmit/receive units (WTRUs) 102a, 102b, 102c, 102d, 102e, 102f, or 102g (which generally or collectively may be referred to as WTRU 102 or WTRUs 102). The communications system 100 may include, a radio access network (RAN) 103/104/105/103b/104b/105b, a core network 106/107/109, a public switched telephone network (PSTN) 108, the Internet 110, other networks 112, and Network Services 113. Network Services 113 may include, for example, a V2X server, V2X functions, a ProSe server, ProSe functions, IoT services, video streaming, or edge computing, etc.

It will be appreciated that the concepts disclosed herein may be used with any number of WTRUs, base stations, networks, or network elements. Each of the WTRUs 102a, 102b, 102c, 102d, 102e, 102f, or 102g may be any type of apparatus or device configured to operate or communicate in a wireless environment. Although each WTRU 102a, 102b, 102c, 102d, 102e, 102f, or 102g may be depicted in FIG. 16A, FIG. 16B, FIG. 16C, FIG. 16D, FIG. 16E, or FIG. 16F as a hand-held wireless communications apparatus, it is understood that with the wide variety of use cases contemplated for 5G wireless communications, each WTRU may comprise or be embodied in any type of apparatus or device configured to transmit or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus, truck, train, or airplane, and the like.

The communications system 100 may also include a base station 114a and a base station 114b. In the example of FIG. 16A, each base stations 114a and 114b is depicted as a single element. In practice, the base stations 114a and 114b may include any number of interconnected base stations or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, or the other networks 112. Similarly, base station 114b may be any type of device configured to wiredly or wirelessly interface with at least one of the Remote Radio Heads (RRHs) 118a, 118b, Transmission and Reception Points (TRPs) 119a, 119b, or Roadside Units (RSUs) 120a and 120b to facilitate access to one or more communication networks, such as the core network 106/107/109, the Internet 110, other networks 112, or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, or other networks 112

TRPs 119a, 119b may be any type of device configured to wirelessly interface with at least one of the WTRU 102d, to facilitate access to one or more communication networks, such as the core network 106/107/109, the Internet 110, Network Services 113, or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations or network elements (not shown), such as a Base Station Controller (BSC), a Radio Network Controller (RNC), relay nodes, etc. Similarly, the base station 114b may be part of the RAN 103b/104b/105b, which may also include other base stations or network elements (not shown), such as a BSC, a RNC, relay nodes, etc. The base station 114a may be configured to transmit or receive wireless signals within a particular geographic region, which may be referred to as a cell (not shown). Similarly, the base station 114b may be configured to transmit or receive wired or wireless signals within a particular geographic region, which may be referred to as a cell (not shown) for methods, systems, and devices of NR SL operation in licensed or unlicensed spectrum, as disclosed herein. Similarly, the base station 114b may be configured to transmit or receive wired or wireless signals within a particular geographic region, which may be referred to as a cell (not shown). The cell may further be divided into cell sectors. For example, the cell associated with the base station 114a may be divided into three sectors. Thus, in an example, the base station 114a may include three transceivers, e.g., one for each sector of the cell. In an example, the base station 114a may employ multiple-input multiple output (MIMO) technology and, therefore, may utilize multiple transceivers for each sector of the cell.

The base stations 114a may communicate with one or more of the WTRUs 102a, 102b, 102c, or 102g over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, or RSUs 120a, 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c, 102d, 102e, or 102f may communicate with one another over an air interface 115d/116d/117d, such as Sidelink communication, which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) or Evolved HSPA (HSPA+). HSPA may include High-Speed Downlink Packet Access (HSDPA) or High-Speed Uplink Packet Access (HSUPA).

In an example, the base station 114a and the WTRUs 102a, 102b, 102c, or RRHs 118a, 118b, TRPs 119a, 119b, or RSUs 120a, 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) or LTE-Advanced (LTE-A). In the future, the air interface 115/116/117 or 115c/116c/117c may implement 3GPP NR technology. The LTE and LTE-A technology may include LTE D2D and V2X technologies and interfaces (such as Sidelink communications, etc.). Similarly, the 3GPP NR technology includes NR V2X technologies and interface (such as Sidelink communications, etc.).

The base station 114a in the RAN 103/104/105 and the WTRUs 102a, 102b, 102c, and 102g or RRHs 118a, 118b, TRPs 119a, 119b or RSUs 120a, 120b in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 16A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like, for implementing the methods, systems, and devices of NR SL operation in licensed or unlicensed spectrum, as disclosed herein. In an example, the base station 114c and the WTRUs 102, e.g., WTRU 102e, may implement a radio technology such as IEEE 802.11 to establish a wireless local area network (WLAN). similarly, the base station 114c and the WTRUs 102d, may implement a radio technology such as IEEE 802.15 to establish a wireless personal area network (WPAN). In yet another example, the base station 114c and the WTRUs 102, e.g., WTRU 102e, may utilize a cellular-based RAT (e.g., WCDMA, CDMA2000, GSM, LTE, LTE-A, NR, etc.) to establish a picocell or femtocell. As shown in FIG. 16A, the base station 114cmay have a direct connection to the Internet 110. Thus, the base station 114c may not be required to access the Internet 110 via the core network 106/107/109.

The RAN 103/104/105 or RAN 103b/104b/105b may be in communication with the core network 106/107/109, which may be any type of network configured to provide voice, data, messaging, authorization and authentication, applications, or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, packet data network connectivity, Ethernet connectivity, video distribution, etc., or perform high-level security functions, such as user authentication.

Although not shown in FIG. 16A, it will be appreciated that the RAN 103/104/105 or RAN 103b/104b/105b or the core network 106/107/109 may be in direct or indirect communication with other RANs that employ the same RAT as the RAN 103/104/105 or RAN 103b/104b/105b or a different RAT. For example, in addition to being connected to the RAN 103/104/105 or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102a, 102b, 102c, 102d, 102e to access the PSTN 108, the Internet 110, or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned or operated by other service providers. For example, the networks 112 may include any type of packet data network (e.g., an IEEE 802.3 Ethernet network) or another core network connected to one or more RANs, which may employ the same RAT as the RAN 103/104/105 or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links for implementing methods, systems, and devices of NR SL operation in licensed or unlicensed spectrum, as disclosed herein. For example, the WTRU 102g shown in FIG. 16A may be configured to communicate with the base station 114a, which may employ a cellular-based radio technology, and with the base station 114c, which may employ an IEEE 802 radio technology.

Although not shown in FIG. 16A, it will be appreciated that a User Equipment may make a wired connection to a gateway. The gateway maybe a Residential Gateway (RG). The RG may provide connectivity to a Core Network 106/107/109. It will be appreciated that much of the subject matter included herein may equally apply to UEs that are WTRUs and UEs that use a wired connection to connect with a network. For example, the subject matter that applies to the wireless interfaces 115, 116, 117 and 115c/116c/117c may equally apply to a wired connection.

FIG. 16B is a system diagram of an example RAN 103 and core network 106 that may implement methods, systems, and devices of NR SL operation in licensed or unlicensed spectrum, as disclosed herein. As noted above, the RAN 103 may employ a UTRA radio technology to communicate with the WTRUs 102a, 102b, and 102c over the air interface 115. The RAN 103 may also be in communication with the core network 106. As shown in FIG. 16B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 16B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 16B may include a media gateway (MGW) 144, a Mobile Switching Center (MSC) 146, a Serving GPRS Support Node (SGSN) 148, or a Gateway GPRS Support Node (GGSN) 150. While each of the foregoing elements are depicted as part of the core network 106, it will be appreciated that any one of these elements may be owned or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned or operated by other service providers.

FIG. 16C is a system diagram of an example RAN 104 and core network 107 that may implement methods, systems, and devices of NR SL operation in licensed or unlicensed spectrum, as disclosed herein. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink or downlink, and the like. As shown in FIG. 16C, the eNode-Bs 160a, 160b, and 160c may communicate with one another over an X2 interface.

The core network 107 shown in FIG. 16C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned or operated by other service providers.

FIG. 16D is a system diagram of an example RAN 105 and core network 109 that may implement methods, systems, and devices of NR SL operation in licensed or unlicensed spectrum, as disclosed herein. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or more gNBs. The gNode-Bs 180a and 180b may implement MIMO, MU-MIMO, or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink or downlink, and the like. As shown in FIG. 16D, the gNode-Bs 180a and 180b may communicate with one another over an Xn interface, for example.

The core network 109 shown in FIG. 16D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless or network communications or a computer system, such as system 90 illustrated in FIG. 16G.

In the example of FIG. 16D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned or operated by an entity other than the core network operator. It will also be appreciated that a 5G core network may not consist of all of these elements, may consist of additional elements, and may consist of multiple instances of each of these elements. FIG. 16D shows that network functions directly connect with one another, however, it should be appreciated that they may communicate via routing agents such as a diameter routing agent or message buses.

In the example of FIG. 16D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 16D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 16D. The PCF 184 may provide policy rules to control plane nodes such as the AMF 172 and SMF 174, allowing the control plane nodes to enforce these rules. The PCF 184, may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect with network functions, so that network function can add to, read from, and modify the data that is in the repository. For example, the UDR 178 may connect with the PCF 184 via an N36 interface. Similarly, the UDR 178 may connect with the NEF 196 via an N37 interface, and the UDR 178 may connect with the UDM 197 via an N35 interface.

The UDM 197 may serve as an interface between the UDR 178 and other network functions. The UDM 197 may authorize network functions to access of the UDR 178. For example, the UDM 197 may connect with the AMF 172 via an N8 interface, the UDM 197 may connect with the SMF 174 via an N10 interface. Similarly, the UDM 197 may connect with the AUSF 190 via an N13 interface. The UDR 178 and UDM 197 may be tightly integrated.

The AUSF 190 performs authentication related operations and connect with the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect with an AF 188 via an N33 interface and it may connect with other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized approaches for different market scenarios which demands diverse requirements, e.g. in the areas of functionality, performance and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 16D, in a network slicing scenario, a WTRU 102a, 102b, or 102c may connect with an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned or operated by other service providers.

The core network entities described herein and illustrated in FIG. 16A, FIG. 16C, FIG. 16D, or FIG. 16E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIG. 16A, FIG. 16B, FIG. 16C, FIG. 16D, or FIG. 16E are provided by way of example only, and it is understood that the subject matter disclosed and claimed herein may be embodied or implemented in any similar communication system, whether presently defined or defined in the future.

FIG. 16E illustrates an example communications system 111 in which the systems, methods, apparatuses that implement NR SL operation in licensed or unlicensed spectrum, described herein, may be used. Communications system 111 may include Wireless Transmit/Receive Units (WTRUs) 102A, 102B, 102C, 102D, 102E, 102F, a base station gNB 121, a V2X server 124, and Road Side Units (RSUs) 123a and 123b. In practice, the concepts presented herein may be applied to any number of WTRUs, base station gNBs, V2X networks, or other network elements. One or several or all WTRUs 102A, 102B, 102C, 102D, 102E, and 102F may be out of range of the access network coverage 131. WTRUs 102A, 102B, and 102C form a V2X group, among which WTRU 102A is the group lead and WTRUs 102B and 102C are group members.

WTRUs 102A, 102B, 102C, 102D, 102E, and 102F may communicate with each other over a Uu interface 129 via the gNB 121 if they are within the access network coverage 131. In the example of FIG. 16E, WTRUs B and F are shown within access network coverage 131. WTRUs 102A, 102B, 102C, 102D, 102E, and 102F may communicate with each other directly via a Sidelink interface (e.g., PC5 or NR PCS) such as interface 125a, 125b, or 128, whether they are under the access network coverage 131 or out of the access network coverage 131. For instance, in the example of FIG. 16E, WRTU D, which is outside of the access network coverage 131, communicates with WTRU F, which is inside the coverage 131.

WTRUs 102A, 102B, 102C, 102D, 102E, and 102F may communicate with RSU 123a or 123b via a Vehicle-to-Network (V2N) 133 or Sidelink interface 125b. WTRUs 102A, 102B, 102C, 102D, 102E, and 102F may communicate to a V2X Server 124 via a Vehicle-to-Infrastructure (V2I) interface 127. WTRUs 102A, 102B, 102C, 102D, 102E, and 102F may communicate to another UE via a Vehicle-to-Person (V2P) interface 128.

FIG. 16F is a block diagram of an example apparatus or device WTRU 102 that may be configured for wireless communications and operations in accordance with the systems, methods, and apparatuses that implement NR SL operation in licensed or unlicensed spectrum, described herein, such as a WTRU 102 of FIG. 16A, FIG. 16B, FIG. 16C, FIG. 16D, or FIG. 16E, or FIG. 2 (e.g., UE 51a or UE 51b) other Figures herein. As shown in FIG. 16F, the example WTRU 102 may include a processor 78, a transceiver 120, a transmit/receive element 122, a speaker/microphone 74, a keypad 126, a display/touchpad/indicator 77, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 16F and may be an exemplary implementation that performs the disclosed systems and methods for NR SL operation in licensed or unlicensed spectrum described herein.

The processor 78 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 78 may perform signal coding, data processing, power control, input/output processing, or any other functionality that enables the WTRU 102 to operate in a wireless environment. The processor 78 may be coupled to the transceiver 120, which may be coupled to the transmit/receive element 122. While FIG. 16F depicts the processor 78 and the transceiver 120 as separate components, it will be appreciated that the processor 78 and the transceiver 120 may be integrated together in an electronic package or chip.

The transmit/receive element 122 of a UE may be configured to transmit signals to, or receive signals from, a base station (e.g., the base station 114a of FIG. 16A) over the air interface 115/116/117 or another UE over the air interface 115d/116d/117d. For example, the transmit/receive element 122 may be an antenna configured to transmit or receive RF signals. The transmit/receive element 122 may be an emitter/detector configured to transmit or receive IR, UV, or visible light signals, for example. The transmit/receive element 122 may be configured to transmit and receive both RF and light signals. It will be appreciated that the transmit/receive element 122 may be configured to transmit or receive any combination of wireless or wired signals.

In addition, although the transmit/receive element 122 is depicted in FIG. 16F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 78 of the WTRU 102 may be coupled to, and may receive user input data from, the speaker/microphone 74, the keypad 126, or the display/touchpad/indicators 77 (e.g., a liquid crystal display (LCD) display unit or organic light-emitting diode (OLED) display unit. The processor 78 may also output user data to the speaker/microphone 74, the keypad 126, or the display/touchpad/indicators 77. In addition, the processor 78 may access information from, and store data in, any type of suitable memory, such as the non-removable memory 130 or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 78 may access information from, and store data in, memory that is not physically located on the WTRU 102, such as on a server that is hosted in the cloud or in an edge computing platform or in a home computer (not shown). The processor 78 may be configured to control lighting patterns, images, or colors on the display or indicators 77 in response to whether the setup of the NR SL operation in licensed or unlicensed spectrum in some of the examples described herein are successful or unsuccessful, or otherwise indicate a status of NR SL operation in licensed or unlicensed spectrum and associated components. The control lighting patterns, images, or colors on the display or indicators 77 may be reflective of the status of any of the method flows or components in the FIG.'s illustrated or discussed herein (e.g., FIG. 3-FIG. 14, etc.). Disclosed herein are messages and procedures of NR SL operation in licensed or unlicensed spectrum. The messages and procedures may be extended to provide interface/API for users to request resources via an input source (e.g., speaker/microphone 74, keypad 126, or display/touchpad/indicators 77) and request, configure, or query NR SL operation in licensed or unlicensed spectrum related information, among other things that may be displayed on display 77.

The processor 78 may receive power from the power source 134 and may be configured to distribute or control the power to the other components in the WTRU 102. The power source 134 may be any suitable device for powering the WTRU 102. For example, the power source 134 may include one or more dry cell batteries, solar cells, fuel cells, and the like.

The processor 78 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) or determine its location based on the timing of the signals being received from two or more nearby base stations. It will be appreciated that the WTRU 102 may acquire location information by way of any suitable location-determination method.

The processor 78 may further be coupled to other peripherals 138, which may include one or more software or hardware modules that provide additional features, functionality, or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect with other components, modules, or systems of such apparatuses or devices via one or more interconnect interfaces, such as an interconnect interface that may comprise one of the peripherals 138.

FIG. 16G is a block diagram of an exemplary computing system 90 in which one or more apparatuses of the communications networks illustrated in FIG. 16A, FIG. 16C, FIG. 16D and FIG. 16E as well as NR SL operation in licensed or unlicensed spectrum, such as the systems and methods illustrated in FIG. 3 through FIG. 14 described and claimed herein may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, or any other functionality that enables the computing system 90 to operate in a communications network. Coprocessor 81 is an optional processor, distinct from main processor 91, that may perform additional functions or assist processor 91. Processor 91 or coprocessor 81 may receive, generate, and process data related to the methods and apparatuses disclosed herein, such as receiving NR SL operation messages over the control plane.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally include stored data that cannot easily be modified. Data stored in RAM 82 may be read or changed by processor 91 or other hardware devices. Access to RAM 82 or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may include peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may include communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIG. 16A, FIG. 16B, FIG. 16C, FIG. 16D, or FIG. 16E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 78 or 91, cause the processor to perform or implement the systems, methods and processes described herein. Specifically, any of the steps, operations, or functions described herein may be implemented in the form of such computer executable instructions, executing on the processor of an apparatus or computing system configured for wireless or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

In describing preferred methods, systems, or apparatuses of the subject matter of the present disclosure—NR SL operation in licensed or unlicensed spectrum—as illustrated in the Figures, specific terminology is employed for the sake of clarity. The claimed subject matter, however, is not intended to be limited to the specific terminology so selected.

The various techniques described herein may be implemented in connection with hardware, firmware, software or, where appropriate, combinations thereof. Such hardware, firmware, and software may reside in apparatuses located at various nodes of a communication network. The apparatuses may operate singly or in combination with each other to effectuate the methods described herein. As used herein, the terms “apparatus,” “network apparatus,” “node,” “device,” “network node,” or the like may be used interchangeably. In addition, the use of the word “or” is generally used inclusively unless otherwise provided herein.

This written description uses examples for the disclosed subject matter, including the best mode, and also to enable any person skilled in the art to practice the disclosed subject matter, including making and using any devices or systems and performing any incorporated methods. The disclosed subject matter may include other examples that occur to those skilled in the art (e.g., skipping steps, combining steps, or adding steps between exemplary methods disclosed herein).

Methods, systems, and apparatuses, among other things, as described herein may provide for SL operation in unlicensed spectrum. A method, system, computer readable storage medium, or apparatus may provide for sharing, by a TX UE, a COT with one or more RX UEs; and sharing, by the TX UE, the COT with one or more other TX UEs. SL COT may be shared based on SL transmission gap or SL transmission duration. The COT may be initiated by a UE. The COT may be shared with the RX UEs or the TX UEs based on SL transmission duration. The COT may be shared with the RX UEs or the TX UEs based on SL transmission gap. A method, system, computer readable storage medium, or apparatus may provide for transmitting a sidelink (SL) transport block to a remote WTRU receiving sidelink (SL) configuration information; measuring listen-before-talk (LBT) failure rate; determining whether the LBT failure rate is below a failure rate threshold; based on the determining that the LBT failure rate is below the threshold, determining whether an explicit negative acknowledgment has been received within a first threshold period, the first threshold period starting when the SL transport block is transmitted; when an explicit acknowledgment is not received during the first threshold period for the SL transport block, indicating a negative acknowledgment; and based on the negative acknowledgement, send a retransmission of the SL transport block to the remote WTRU. Based on the determining that the LBT failure rate is above the failure rate threshold, determining whether an explicit acknowledgment has been received within a second threshold period, the second threshold period starting when a SL transport block is transmitted. A method, system, computer readable storage medium, or apparatus may provide for receiving a sidelink ACK feedback indicator (SL-AFI) from the remote WTRU. The SL-AFI may include a bitmap. The SL-AFI may correspond to a plurality of scheduled hybrid automatic repeat request (HARQ) processes. All combinations in this paragraph (including the removal or addition of steps) are contemplated in a manner that is consistent with the other portions of the detailed description.

What is claimed is:

1-15. (canceled)

16. A wireless transmit/receive unit (WTRU) comprising a processor and a memory, the processor configured to:
transmit a sidelink (SL) transport block to a remote WTRU;
receive SL configuration information;
measure listen-before-talk (LBT) failure rate;
determine whether the LBT failure rate is below a failure rate threshold;
based on a determination that the LBT failure rate is below the failure rate threshold, determine whether an acknowledgement (ACK) or a negative acknowledgment (NACK) has been received within a first threshold period, the first threshold period starting when the SL transport block is transmitted;
wherein, upon a determination that a NACK is received during the first threshold period, retransmit the SL transport block to the remote WTRU; and
wherein, upon a determination that a NACK is not received during the first threshold period, determine an ACK associated with the SL transport block.

17. The WTRU of claim 16, wherein the NACK is indicated via a SL indicator in a SL transmission from the remote WTRU and an ACK is indicated via a SL indicator received in a SL transmission from the remote WTRU, wherein the SL indicator comprises a bitmap.

18. The WTRU of claim 16, wherein the processor is configured to:
determine that the LBT failure rate is above the failure rate threshold;
based on a determination that the LBT failure rate is above the failure rate threshold, determine whether an explicit ACK has been received within a second threshold period, the second threshold period starting when the SL transport block is transmitted;
determine a NACK when an ACK is not received within the second threshold period; and
retransmit the SL transport block to the remote WTRU based on the determination of the NACK.

19. The WTRU of claim 18, wherein the processor is configured to:
determine that an ACK is received within the second threshold period.

20. The WTRU of claim 16, wherein the processor is configured to receive a SL indicator from the remote WTRU, wherein the SL indicator comprises information corresponding to a plurality of scheduled hybrid automatic repeat request (HARQ) processes.

21. The WTRU of claim 16, wherein the WTRU performs LBT after receiving SL configuration information.

22. A method performed by a wireless transmit/receive unit (WTRU), the method comprising:
transmitting a sidelink (SL) transport block to a remote WTRU;
receiving SL configuration information;
measuring listen-before-talk (LBT) failure rate;
determining that the LBT failure rate is below a failure rate threshold, wherein a first threshold period is used when the LBT failure rate is above the failure rate threshold, and a second threshold period is used when the LBT failure rate is below the failure rate threshold, wherein the first threshold period or the second threshold period is started when the SL transport block is transmitted; and
upon determining that the LBT failure rate is above the failure rate threshold and an acknowledgment (ACK) has not been received within a second threshold period, determining a negative acknowledgment (NACK) and retransmitting the SL transport block to the remote WTRU; or
upon determining that the LBT failure rate is below the failure rate threshold and a NACK has not been received within a first threshold period, determining an ACK associated with the SL transport block.

23. The method of claim 22, wherein the NACK is indicated via a SL indicator received in a SL transmission from the remote WTRU, and an ACK Is indicated via a SL indicator received in a SL indicator received in a SL transmission from the remote WTRU, wherein the SL indicator comprises a bitmap.

24. The method of claim 22, further comprising:
receiving a SL indicator from the remote WTRU, wherein the SL indicator comprises information corresponding to a plurality of scheduled hybrid automatic repeat request (HARQ) processes.

25. The method of claim 22, wherein the WTRU performs LBT after receiving SL configuration information.

26. A computer-readable storage medium comprising executable instructions that, when executed by one or more processors, cause the one or more processors to:
transmit a sidelink (SL) transport block to a remote WTRU;
receive SL configuration information;
measure listen-before-talk (LBT) failure rate;
determine whether the LBT failure rate is below a failure rate threshold;
based on a determination that the LBT failure rate is below the failure rate threshold, determine whether an acknowledgement (ACK) or a negative acknowledgment (NACK) has been received within a first threshold period, the first threshold period starting when the SL transport block is transmitted;
wherein, upon a determination that a NACK is received during the first threshold period, retransmit the SL transport block to the remote WTRU; and
wherein, upon a determination that a NACK is not received during the first threshold period, determine an ACK associated with the SL transport block.

27. The computer readable storage medium of claim 26, wherein the NACK is indicated via a SL indicator in a SL transmission from the remote WTRU and an ACK is indicated via a SL indicator received in a SL transmission from the remote WTRU, wherein the SL indicator comprises a bitmap.

28. The computer readable storage medium of claim 26, comprising executable instructions that, when executed by the one or more processors, cause the one or more processors to:
determine that the LBT failure rate is above the failure rate threshold; and
based on a determination that the LBT failure rate is above the failure rate threshold, determine whether an explicit ACK has been received within a second threshold period, the second threshold period starting when the SL transport block is transmitted;
determine a NACK when an ACK is not received within the second threshold period; and
retransmit the SL transport block to the remote WTRU based on the indication of the NACK.

29. The computer readable storage medium of claim 28, comprising executable instructions that, when executed by the one or more processors, cause the one or more processors to:
determine that an ACK is received within the second threshold period.
